(19) United States
(12) Patent Application Publication
(10) Pub. No.: US 2025/0191055 A1
(43) Pub. Date: Jun. 12, 2025

(54) System and Methods for Creating E-Commerce Virtual Experiences And Integrating Graphical User Interfaces

(71) Applicant: Zelig Technology, LLC, Los Angeles, CA (US)

(72) Inventors: Sandra Sholl, West Hollywood, CA (US); Bailey Kong, Arcadia, CA (US); Alexander Rodriguez, Marina del Rey, CA (US); Roger Sheu, San Marino, CA (US); Adam Freede, West Hollywood, CA (US); Dave Canfield, West Hollywood, CA (US); Larkin Magner, Los Angeles, CA (US); Spencer Carey, Los Angeles, CA (US)

(21) Appl. No.: 19/056,706

(22) Filed: Feb. 18, 2025

Related U.S. Application Data
(63) Continuation-in-part of application No. 18/378,593, filed on Oct. 10, 2023.
Application No. 18/378,593 is a continuation-in-part of application No. 18/217,412, filed on Jun. 30, 2023.
(60) Provisional application No. 63/554,352, filed on Feb. 16, 2024.
(60) Provisional application No. 63/358,038, filed on Jul. 1, 2022.

(51) Int. Cl. G06Q 30/0601; G06T 3/18; G06T 11/60

(52) U.S. Cl. CPC G06Q 30/0643; G06Q 30/0633; G06T 3/18; G06T 11/60; G06T 2200/24; G06T 2210/16

(57) ABSTRACT

Disclosed are example embodiments of systems and methods that facilitate a unique customer experience in which consumers may virtually try-on of articles of clothing at any online store. The system and methods deliver an easy-to-use experience as a graphical overlay on top of an existing retailer's or brand's online presence, either via mobile or desktop. The e-commerce technology provides a framework for integrating a user interface widget that modifies the user experience of existing retailer e-commerce websites without requiring additional companion software. The widget communicates with any retailer's infrastructure and enables consumers to add articles into the retailer's shopping cart directly using the unique widget. A myriad features personalize and elevate customer experiences. An example method of virtual try-on of articles of clothing includes selecting a garment from a retailer's e-commerce website, loading a photo of a source model wearing the selected garment, and creating different combinations from of different garments for viewing.

### CROSS-REFERENCE TO RELATED APPLICATIONS

The present application claims priority to U.S. Provisional Patent Application No. 63/554,352, filed Feb. 16, 2024, and is a continuation-in-part of U.S. patent application Ser. No. 18/378,593 filed Oct. 10, 2023, which is a continuation-in-part of U.S. patent application Ser. No. 18/217,412, filed Jun. 30, 2023, which claims priority to U.S. Provisional Patent Application 63/358,038, filed Jul. 1, 2022, both of which are hereby expressly incorporated by reference herein.

### BACKGROUND

### 1. Field of the Invention

This disclosure relates generally to the field of image processing and constructing graphical user interfaces (“GUI”) for electronic commerce (“e-commerce”) and, more particularly, and not by way of limitation, some embodiments disclosed herein relate to constructing image processing systems and methods for constructing e-commerce virtual experiences with seamless graphical user interface (“GUI”) integration to digital stores to generate a virtual shopping experience that simulates a real-world shopping experience with dynamic capabilities to generate images quickly in real time from merchants, fashion products, and user profiles and pre-formed styles with using artificial intelligence (“Ar”). Users can start their digital shopping journey via an interactive graphical interface or GUI overlay that enables them to create personalized avatars, and curate and style articles of real-world clothing by fast image creation.

### 2. Description of the Related Art

The ubiquity of desktop and laptop computers, smart phones, tablet computer and other personal computing devices has accelerated use of such devices to engage in personal and professional online activities on a daily basis. Such devices include cameras, permitting users to capture images or video sequences of themselves or others with ease and use the acquired images, in live interactions.

In the commercial realm, global e-commerce is growing rapidly. It is expanding into the world of clothing and fashion. Online shopping is overwhelming, with endless selections, but digital experiences that are impersonal and slow. Enhanced shopping experiences remain a crucial focus of e-commerce growth.

Recent attempts to leverage personal computing devices including cameras into online shopping activities enable users to virtually dress or “try-on” clothing articles available for online purchase directly from a retailer or a merchant's digital store. However, such systems provide limited customer satisfaction. For example, certain systems require customers to provide views of themselves from myriad different perspectives, which often requires assistance of another person, making the entire customer experience tedious and time consuming. Existing systems also are not known to permit users to select a desired styling of a clothing article or garment (e.g., sleeves rolled up, sleeves below wrist, garment tucked in or untucked, etc.) when virtually trying on the article. Moreover, existing “try-on” systems are generally incapable of manipulating clothing articles to be tried on to realistically drape or deform clothing on a variety of different user poses.

Accordingly, a need exists for improved and seamless customer experiences and e-commerce solutions that elevate the user experience to emulate a delightful in-store experience, facilitating a shopping journey with fast image generation involving, virtually styling and trying on clothes from the online presence of different stores with ease.

### SUMMARY

The techniques introduced herein overcome the deficiencies and limitations of the prior art, at least in part, by providing a unique and dynamic e-commerce technology that constructs an elevated virtual shopping journey with personalized experiences for users in an e-commerce landscape, with fast image generation of data from merchants (or retailers), clothing types, and user profiles synthesized by AI and machine learning in real time with partial real-time data and carousels of preconstructed styles. In some embodiments, consumers or users (also referred to as digital shoppers herein) can create human representations of themselves (referred to as personalized avatars herein) and curate combinations of clothing items or garments, with accessories, shoes, jewelry etc., to create styled “looks,” using fast generation of data and “try-one” technology. This e-commerce shopping journey is created via graphical user interface components that are configured to easily integrate with the online presence of different stores to facilitate seamless integration with collaborating merchants and retailers using their assets for fast generation of images. The images include styling different variations of clothes quickly and storing them in personal customer digital closets that serve as a fashion repository. These digital closets, otherwise referred to as virtual closets can accompany a customer through various stages of life, from a young teenager, to you adult, through a customer's mature years. Styles may be curated by a customer or recommendations from a merchant's digital store or the e-commerce platform in accordance with the present invention by fast generation of data. Variations of styles may be created from different retailers for and virtual try-on by online customers and storing in the digital closets. All the embodiments described here are trying to mimic the experience of visiting a store or shop in real life to try on different garments. These virtual try-one technologies help the user visualize the garments on their body, or a body similar to theirs. This creates a superior user experience and improves the likelihood of the user purchasing items and/or reduces the likelihood of the user returning the items they purchased.

The e-commerce virtual system and methods deliver an entire online shopping journey to consumers (otherwise referred to as users or digital shoppers), simulating unparalleled digital shopping experiences, that can accompany consumers through their years of shopping. The e-commerce virtual system has a unique graphical user interface (interactive software) is overlay on top of an existing retailer or brand's online presence, either mobile or desktop. This technology eliminates any requirement for a user to download additional applications or visit a third-party site to accomplish the elevated shopping experience. The e-commerce virtual system and methods described here are delivered within websites or applications that are already operational and actively conducting online sales.

In some example embodiments, the virtual try-on technology disclosed herein allows consumers to try-on virtual garments that are digital representations of real-world items as part of an online shopping experience. These garments may be “tried on” virtually by customers on a digital representation of human body (avatar), which may be created by either using a user-uploaded photograph of themselves or by selecting a human model from many different model types. The different model types may include a live human, for example, a video of a live person who is similar in appearance, shape or size to the consumer. These human body shapes may be viewed in an augmented reality (AR) or virtual reality (VR) experience, or on a conventional mobile or desktop browser.

In some example embodiments, the virtual try-on system and methods facilitate shopper likeness by using the e-commerce virtual widget. In such instances, shopper likeness is similar in look and shape. If consumers upload a photograph of themselves or a live image to create their avatar, the widget software has an interactive interface that guides consumers with real-time feedback to adhere to guidelines with defined metrics to ensure photo quality and reduce errors during image capture.

In some example embodiments, the interactive interface presents options for consumers via the interactive interface to modify their human body representation by making selections from different body shapes, sizes, heights, skin tones, ethnicities, hair colors, age and like, to create an image then can identify with. These options simulate a full-length in-store mirror experience virtually, permitting users to see their full body with selected items of an outfit in a complete ensemble with accessories, shoe, socks etc.

In some example embodiments, the e-commerce virtual system and methods integrates and communicates with a retailer's infrastructure to modify consumer experiences on the retailer's e-commerce website. For example, consumers can add products to the retailer's cart directly from the unique graphical user interface overlay widget. In some example embodiments, the interactive interface offers users the ability to mix and match different garments, i.e., a single garment or multiple garments, from the online presence of retailer inventories to create the virtual outfits in real time. For example, a consumer may select a pair of pants and a t-shirt to see how they look together. The interactive interface (“styler widget”) displays the selected human body likeness image with digital representation of garments that are digitally warped to fit the human body representation in a lifelike manner.

In some example embodiments, in the event a user selects a single garment, the styler widget retrieves the retailer's existing recommendation algorithms to add additional elements to complete the outfit, e.g., a bottom, shoes or the like. With every garment added, the human body image created for each user changes instantly to wear the garment or accessory selected. In some example embodiments, the styler widget facilitates browsing the retailer's product catalog for garments and other items of interest. The human body representation is displayed wearing the last outfit in a designated section of the screen, as a user browses through the retailer's online inventory. In example embodiments, the styler widget enables a user to try different styling variations of a garment. For example, styling options are displaying a t-shirt tucked or untucked. In some embodiments, users may add or remove layers of clothing via a designated number of layering options integrated within the styler widget.

In some embodiments, users may save their complete outfit (or “look”) in a digital closet for a visual reminder of their personalized choices. Users can access their closets from each retailer's store and proceed to a purchase transaction via the retailer cart. These digital closets can accompany users through their life journey, staying with them as they grow over the years. Users can remove items of clothing to clear their digital closets and change styles saved in their digital closets as their fashion preferences evolve or change.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 provides a high-level block diagram of an exemplary system and methods with seamless graphical user interface (GUI) integration in e-commerce to facilitate try-on of real-world clothing or garments virtually in accordance with the disclosure.

FIG. 2 is a block diagram illustrating the hardware and software components of GUI integration system in accordance with the disclosure.

FIG. 3 is a block diagram illustrating an example e-commerce infrastructure of multiple retailers with their respective online presence in communication with the e-commerce virtual and GUI integration system in accordance with the disclosure.

FIG. 4 is a block diagram illustrating an example e-commerce virtual and GUI integration system in accordance with the disclosure.

FIG. 5 is a block diagram illustrating the GUI interactive widget interacting with an example retailer's product catalog and one or more databases associated with the GUI interactive widget.

FIG. 6 is a block diagram illustrating the GUI interactive widget interacting with the retailer's shopping cart.

FIG. 7 is a block diagram illustrating an example implementation of database multilayer architecture showing example attributes associated with the GUI interactive widget.

FIG. 8 is a block diagram illustrating an example implementation of a multi-layer database architecture with example multi-class attributes associated with different garments and accessories which the GUI interactive widget is trained to recognize.

FIG. 9 is a block diagram illustrating an example e-commerce virtual and GUI overlay widget.

FIG. 10 is a block diagram illustrating an example data storage associated with the e-commerce virtual system components.

FIG. 11 is a block diagram illustrating an example shopper likeness engine.

FIG. 12 is a flow chart providing an overview of creating a human body representation to represent shopper likeness.

FIG. 13 is a flow chart providing an overview of a process for trying on a single garment by a user via the GUI integration system.

FIG. 14 is a flow chart providing an overview of a process for trying on multiple garments by a user via the GUI integration system.

FIG. 15 is a flow chart providing an overview of a process for product browsing via the GUI integration system.

FIG. 16 is a flow chart providing an overview of a process for e-commerce virtual via the GUI integration system.

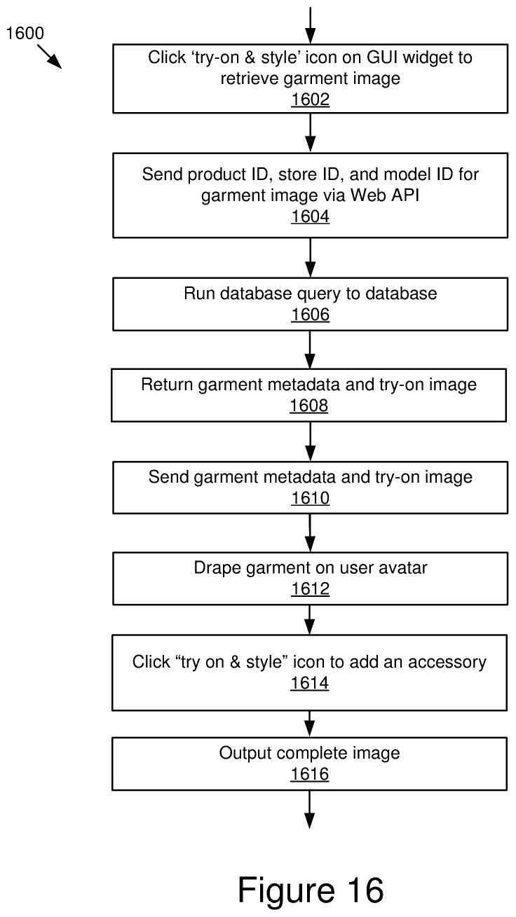

FIG. 17 provides an overview of operation of an example machine-learning try-on/styling pipeline in accordance with the disclosure.

FIG. 18 illustrates an example implementation of a GUI integration system presenting options to select a human body model to match user likeness in accordance with the disclosure.

FIG. 19 illustrates an example implementation of a GUI integration system presenting options to select a human body model to match user likeness in accordance with the disclosure.

FIG. 20 illustrates an example implementation of the Styler widget, formatted for mobile devices, specifically, illustrating that the user has selected a sweater and the other items are showcased to the user as recommendations.

FIG. 21 illustrates an example implementation of the Styler widget, formatted for desktop viewing, specifically, illustrating that the user has selected a sweater and the other items are showcased to the user as recommendations.

FIG. 22 illustrates an example implementation of the Styler widget, formatted for viewing on mobile devices, wherein the user has selected the recommended items and tried them on their virtual model.

FIG. 23 illustrates an example implementation of the Styler widget, formatted for desktop viewing, where the user has selected the recommended items and tried them on their virtual model.

FIG. 24 illustrates an example implementation of the Styler widget, formatted for mobile devices, wherein the user is browsing different tops via the Styler widget, by using the right and left swipes (or arrows) to present different options.

FIG. 25 illustrates an example implementation formatted for desktop viewing, wherein the user has opted to try new bottoms on their virtual model and browses different rearrows) to present different options.

FIG. 26 is an example implementation illustrating the user leaving the Styler widget, and shown (on a mobile device) as browsing the retailer's product listing pages. As illustrated, the last virtual outfit the user tried on is displayed on the middle-right of the screen, referred to as the “Mirror.”

FIG. 27 is an example implementation illustrating the user leaving the Styler widget, and shown (formatted for desktop viewing) browsing through the retailer's product listing pages. The last virtual outfit that the user tried on is displayed on the middle-right of the screen, referred to as the “Mirror.”

FIG. 28 illustrates a GUI display overlay formatted for desktop viewing, of a personalized avatar in a complete outfit with accessories.

FIG. 29 illustrates a GUI display overlay formatted for mobile viewing, a personalized avatar in a complete outfit.

FIG. 30 illustrates a GUI display overlay formatted for desktop viewing of items saved to a virtual closet that can be virtually “tried on,” again or added to a retailer's existing cart.

FIG. 31 illustrates a GUI display overlay formatted for mobile viewing of items saved to a virtual closet that can be virtually “tried on” again or added to a retailer's existing cart.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Some embodiments of the systems and methods described herein include a e-commerce virtual graphical user interface (GUI) integration system with seamless capability to integrate with the existing presence of online retailers. The GUI integration system provides an enhanced, personalized in-store experience for users with multi-faceted styling capability for clothing and accessories. In some embodiments, the present invention relates to a e-commerce virtual GUI integration system that allows users to access any retailer's online store or website, via interactive software to virtually try on single or multiple clothing items or garments (and accessories). The interactive software described in the present disclosure provides enhanced styling options including creating a human body visual representation, also referred to as an avatar herein, personalizing it to assume a user or shopper's likeness, and navigating different retailer websites with this personalized avatar to virtually try one garments, accessories, etc. The interactive software advantageously integrates with any retailer's existing infrastructure. The GUI integration system may utilize advanced computer vision and machine learning and augmented reality technologies to create a realistic and immersive e-commerce virtual experience. By incorporating styling capabilities and unique GUI features, users may be able to personalize and customize their virtual outfits to suit their preferences. The GUI integration system utilizes an intuitive user interface to allow a user to traverse the existing e-commerce infrastructure and its vast distributed database of clothing styles and accessories to provide a seamless and enjoyable virtual shopping experience (by fast generation of images). Styles are provided to uses by fast generation of images and real time image creation.

In some embodiments, the GUI integration and e-commerce virtual system with enhanced styling capability for clothing described herein enables users to visualize and evaluate the appearance of clothing items virtually without physically wearing them. Some example GUI integration systems and methods may combine state-of-the-art computer vision algorithms, machine learning algorithms, augmented reality techniques, and a vast distributed clothing style database across the retail infrastructure to create a realistic and interactive e-commerce virtual experience.

In an example embodiment, the e-commerce virtual process may begin with a user selecting a clothing item or garment from the system's extensive distributed database. The database may include various garments such as tops, bottoms, dresses, jackets, and accessories. Each clothing item may be digitally rendered to accurately represent clothing item's design, color, texture, and fit, and each accessory's design, color, texture, or other attributes of the accessory.

In an example embodiment, once the user selects a clothing item, the GUI integration system may initiate the e-commerce virtual process. Before the e-commerce virtual process, a user may set up a human body visual representation to create a personalized avatar that will accompany the user on its shopping experience in the retail e-commerce environment. The user may create the personalized avatar by either providing (e.g., uploading) a photograph or selecting an image of a human model that is similar in appearance (e.g., a live image, a video). To create the personalized avatar, using computer vision and machine learning algorithms, the GUI integration system detects and analyzes the user's body shape, size, and proportions based on the image provided or video input. The algorithms map the user's body onto a virtual model, creating a personalized avatar that accurately represents the user's physique or shape.

In some example embodiments, the selected clothing item may then be dynamically fitted onto the user's virtual avatar. Advanced simulation algorithms account for fabric draping, stretching, and body movement to provide a realistic representation of how the clothing would appear on the user. An example embodiment may have enhanced styling capabilities. The e-commerce virtual system may go beyond mere visualization by incorporating enhanced styling capabilities. For example, in some embodiments, users may be able to personalize their virtual outfits by selecting different clothing combinations (e.g., a single garment or multiple garments, adjusting garment parameters (e.g., sleeve length, neckline, top button unbuttoned, multiple unbuttoned buttons, or other styling), and experimenting with color variations. In an example embodiment, the GUI integration system may allow users to mix and match various clothing items or garments and/or accessories to create unique ensembles. The unique ensembles may be saved for later reference in a virtual closet. Additionally, the GUI integration system may provide accessory options such as shoes, bags, jewelry, hats, and/or other accessory options, enabling users to complete their virtual outfits with coordinating elements. In some examples, users can preview different accessories on their avatar and evaluate the overall styling effect.

In an example embodiment, the unique user interactive interface and controls may be used to control the systems and methods described herein. In an example embodiment, the GUI integration system with e-commerce virtual elements features an intuitive and user-friendly interface that may facilitate easy navigation and customization. Users may easily interact with the GUI integration system through a smartphone application, a computer application, a web-based platform, dedicated virtual reality (VR) headsets, or other electronic computing device.

The user interface software may provide controls for selecting clothing items, adjusting garment parameters, and exploring styling options. Users can browse through the distributed clothing database (any retailer's existing online presence), filter items by category, style, color, or brand, and view detailed product descriptions and user reviews.

An example embodiment may include seamless integration with one or more distributed e-commerce platforms. To elevate the shopping experience, the GUI integration system with e-commerce virtual elements may seamlessly integrate with distributed e-commerce platforms concurrently. Users may be able to directly purchase the clothing items they try on or add them to a Wishlist held in a virtual closet for future reference. The GUI integration system provides links to online retailers, allowing users to access additional product information and make informed purchase decisions.

In addition to the core e-commerce virtual and styling capabilities, the GUI integration system may include one or more supplementary features. These may include product browsing on retailer websites. These may also include the capability to modify their personalized avatar with changing body measurements. For example, the GUI integration system may offer tools to help users accurately measure their body dimensions, ensuring better fitting virtual garments. Real time feedback may assist users to follow strict guidelines to ensure creating a real-life visual representation of themselves. The capability to store garments of interest in a virtual closet (also referred to herein as a digital closet) for subsequent viewing and/or purchase revolutionizes the way users interact with fashion in the digital world.

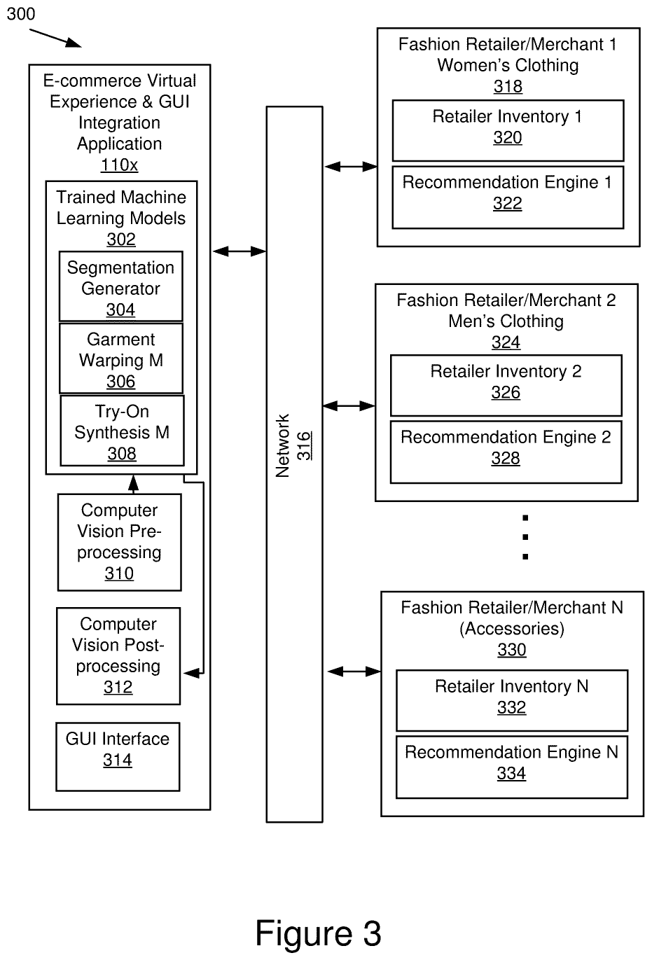

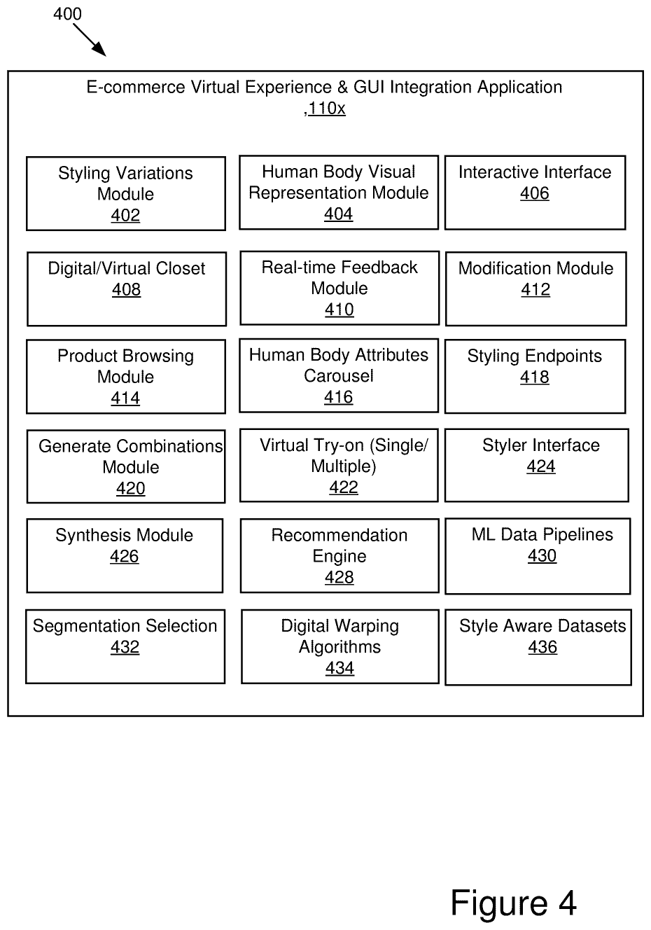

In some embodiments, the present disclosure provides a GUI integration system and methods for e-commerce virtual of, and subscription access to, digital representations of real-world garments with selected styling using machine learning. The present GUI integration system enables a user to experience online/e-commerce virtual of unlimited offered styles/articles of virtual clothing (e.g., representing real-world clothing stored in carousels of pre-formed or pre-constructed styles provided to consumers at high speed (for example, 1-3 seconds)) or within a very short time (e.g., 5-10 seconds) following submission of a photo or live image of the user. The carousel of styled images results by fast image generation and may be delivered in blasts of styles in quick succession. In an example implementation the present system may utilize a first machine learning pipeline to create style-aware datasets based upon a large set of images of garments obtained from, for example, various open-source repositories of images, via paid licenses of images, affiliate company's images, or any other sources of images. These style-aware datasets are then used in a second machine learning pipeline, i.e., a try-on/styling pipeline, to train a set of machine learning models. In one implementation these machine learning models include a segmentation generator (304, FIG. 3), a warping model and a try-on synthesis model (synthesis module 426, FIG. 4). During the training process quantitative and potentially qualitative evaluation of performance of the models may be used to infer or otherwise determine checkpoints to be promoted for each model.

Once the segmentation generator 304, warping model and try-on synthesis model (synthesis module 426, FIG. 4) have been trained, the try-on/styling pipeline may be utilized in conjunction with computer vision and machine learning pre-processing and post-processing modules to facilitate e-commerce virtual of digital garments, e.g., digital representations of real-world garments, styled in accordance with a fashion standard, e.g., a high-fashion standard. In one embodiment the e-commerce virtual process is initiated when a user application executing on a mobile device sends input information to a server platform (e.g., a cloud-based server or a hosted server) executing the try-on/styling pipeline. This input information may typically include information identifying a ghost image of a selected digital garment, a front facing image of a user desiring to virtually try-on the digital garment, and an indication of a fashion style in which the user desires to “wear” the garment. In accordance with one aspect of the disclosed system the result of the e-commerce virtual process is an image of the user wearing the digital garment in the user-selected fashion style.

Once the input information is received at the server platform, a computer vision and machine learning pre-processing operation may be performed pursuant to which various checks are made on the image provided by the user (e.g., only one person in the image, only certain poses permitted, etc.). Once these checks are performed various pre-processing operations may also be carried out (e.g., remove background and replace it with a white or other uniform background). These pre-processing operations will also include generating all features required by the segmentation generator (304, FIG. 3), the warping model and the try-on synthesis model (synthesis module 426, FIG. 4). The segmentation generator then utilizes a model (checkpoint) to, based on the selected garment and the initial body segmentation determined during pre-processing, predict the target area of the garment in the segmentation. The trained warping model (checkpoint) then deforms the garment based on the predicted segmentation. The trained try-on synthesis model (checkpoint) then executes, based upon styling customizations conforming to, for example, a high-fashion standard, or some other standard, the predicted segmentation, and the warped garment, transfer of a fashion styled garment to a cloth agnostic representation of the user. This results in a live generated image of the user wearing, in the user-selected style and/or styled look, the fashion styled digital garment in a pose identified from the user's input image in a very short time (e.g., 5 to 10 seconds).

In one embodiment post-processing of the generated image is employed to improve the generated machine learning output and to detect if the generated image is of sufficient quality to be returned to the user. For example, the generated image may be evaluated to determine if the image features are not within a distribution of images having styling features corresponding to a particular category of a digital styling taxonomy. The post-processing may also include, for example, performing segmentation and computing body part proportions. Other post-processing may include performing pose detection and identifying any anomalous poses or body configurations (e.g., 3 arms, 2 heads, 3 legs, and so on).

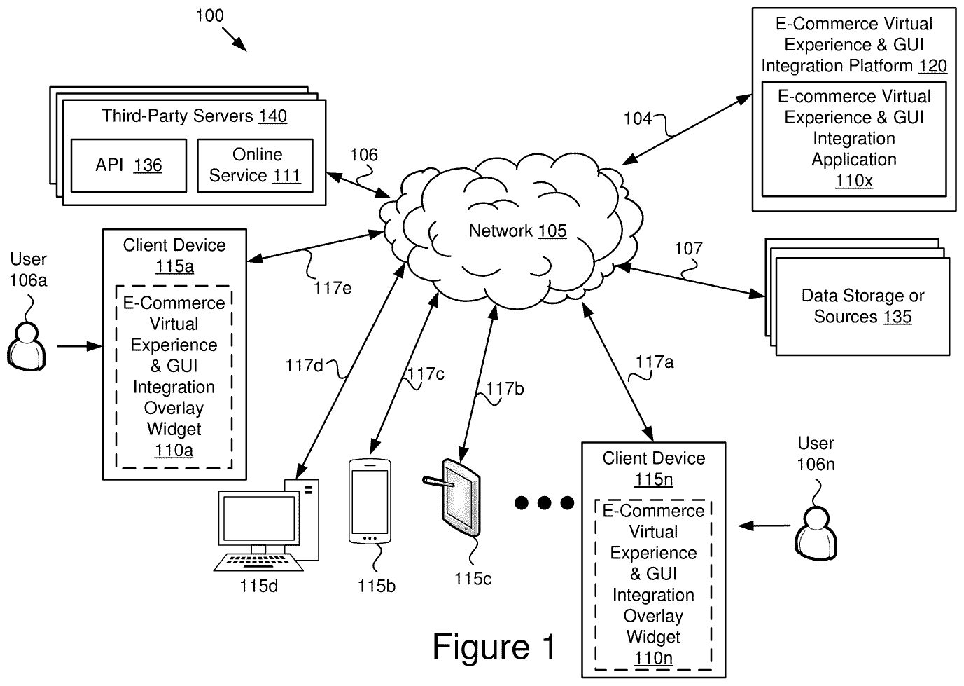

Referring now to FIG. 1, which provides an overview of an example e-commerce virtual and GUI integration system 100 designed to seamlessly integrate with existing retailer digital storefronts (websites) for e-commerce virtual of digital representations of real-world garments by personal avatars created in accordance with the disclosure. The e-commerce virtual and GUI integration system 100 includes a digital garment e-commerce virtual and GUI platform 120 in communication with any number of client devices 115 a-n. Multiple client devices 115a through 115n are illustrated. Client devices include a mobile device 115b, a notebook 115c, a desktop 115d, or like electronic device, over a network connection 105, which may include multiple wireless and/or wired networks. Each of the client devices is communicatively connected to the network 105 via signal lines 117a through 117e for interaction and electronic communication with other platforms. In some implementations, a client device 115 may include a memory, a processor (e.g., virtual, physical, etc.), a power source, a network interface, software and/or hardware components, such as a display, graphics processing unit (GPU), wireless transceivers, keyboard, camera (e.g., webcam), sensors, firmware, operating systems, web browsers, applications, drivers, and various physical connection interfaces (e.g., USB, HDMI, etc.). The client devices 115a-115n may couple to and communicate with one another and the other entities of the system 100 via the network 105 using a wireless and/or wired connection.

The network 105 may be a conventional type, wired or wireless, and may have numerous different configurations including a star configuration, token ring configuration, or other configurations. Furthermore, the network 105 may include any number of networks and/or network types. For example, the network 105 may include a local area network (LAN), a wide area network (WAN) (e.g., the Internet), virtual private networks (VPNs), mobile (cellular) networks, wireless wide area network (WWANs), WiMAX® networks, Bluetooth® communication networks, peer-to-peer networks, near field networks (e.g., NFC, etc.), and/or other interconnected data paths across which multiple devices may communicate, various combinations thereof, etc. The network 105 may also be coupled to or include portions of a telecommunications network for sending data in a variety of different communication protocols. In some implementations, the network 105 may include Bluetooth communication networks or a cellular communications network for sending and receiving data including via short messaging service (SMS), multimedia messaging service (MMS), hypertext transfer protocol (HTTP), direct data connection, WAP, email, etc. In some implementations, the data transmitted by the network 105 may include packetized data (e.g., Internet Protocol (IP) data packets) that is routed to designated computing devices coupled to the network 105. Although FIG. 1 illustrates one network, in practice one or more networks 105 can be connected to the entities illustrated.

The e-commerce virtual and GUI integration platform 120 is coupled to the network via signal line 104. In some implementations, the platform 120 combines styling, virtual-try on, a digital closet, user profiles, a mirror function, and a stylist (human) approval or rejection input. In some implementations, the e-commerce virtual and GUI integration platform 120 may be a hardware server, a software server, or a combination of hardware and software. For example, the e-commerce virtual and GUI integration platform 120 may include one or more virtual servers, which operate in a host server environment and access the physical hardware of the host server including, for example, a processor, a memory, applications, a database, storage, network interfaces, etc., via an abstraction layer (e.g., a virtual machine manager). In some implementations, the e-commerce virtual and GUI integration platform 120 may be a Hypertext Transfer Protocol (HTTP) server, a Representational State Transfer (REST) service, or other server type, having structure and/or functionality for processing and satisfying content requests and/or receiving content from one or more of the client devices 115, the plurality of data sources and the plurality of third-party servers 140 that are coupled to the network 105. Each of the one or more third-party servers 140 may be, or may be implemented by, a computing device including a processor, a memory, applications, a database, and network communication capabilities. A third-party server 140 may be a Hypertext Transfer Protocol (HTTP) server, a Representational State Transfer (REST) service, or other server type, having structure and/or functionality for processing and satisfying content requests and/or requesting and receiving content from one or more of the client devices 115, the data sources 135, and the platform 120 that are coupled to the network 105.

Each of the plurality of data sources 135 may be, or may be implemented by, a computing device including a processor, a memory, applications, a database, and network communication capabilities. In some implementations, the data sources may be a data warehouse, a system of record (SOR), or belonging to a data repository owned by an organization that provides real-time or close to real-time data automatically or responsive to being polled or queried by the platform 120. Each of the plurality of data sources 135 may be associated with a first-party entity (e.g., platform 120) or third-party entity (e.g., server 140 associated with a separate company or service provider).

The mobile device 115 executes a user application 110a-n which, in cooperation with platform 120 facilitates e-commerce virtual of digital garments (for purchase or rent) in accordance with the disclosure. The user application 110a-n is a e-commerce virtual and GUI overlay widget. In certain embodiments the user application 110 is also configured to support providing fashion styling recommendations, e.g., high-fashion styling recommendations by a retailer, to a user of the mobile device 115 and to enable the sharing of images of the user's personalized avatar wearing digital garments styled in conformity with fashion standards.

In one embodiment, the platform 120 may be implemented using “cloud” computing capabilities. As is known, cloud computing may be characterized as a model for facilitating on-demand network access to a shared pool of configurable computing resources (e.g., networks, servers, storage, applications, and services) that can be rapidly provisioned and released with minimal management effort or service provider interaction. Cloud systems are configured to automatically control use of resources by utilizing some form of metering capability with respect to, for example, storage, processing, bandwidth, and active user accounts. Various cloud service models are possible, including cloud software as a service (SaaS), cloud platform as a service (PaaS), and cloud infrastructure as a service (laaS).

In other embodiments, platform 120 may be implemented by using on-premises servers and other infrastructure rather than by using cloud-based services. Alternatively, hybrid implementations of the attribution computation platform 120 including a combination of on-premises and cloud-based infrastructure are also within the scope of the present disclosure.

As illustrated, the e-commerce virtual platform includes a e-commerce virtual GUI integration system 110x, which is configured to seamlessly integrate with existing retailer infrastructure. The e-commerce virtual GUI integration system 110x interacts with the e-commerce virtual GUI overlay widgets 110a-110n on the client devices 115a-115n. Consumers or users 106a and 106n seeking an in-store customer experience can go to retailer websites and browse through their products, select items of interest, including garments, accessories, shoes and the like, and wear them on their digital avatars. Also illustrated are multiple data storage or sources 135 connected to the network via signal line 107 and third-party servers 140 connected to the network 105 via signal line 106. The third-party server 140 include an application programming interface (API) 136, and an online service 111. The third-party servers 140 represent the external infrastructure with which the platform 120 interacts, for example retailers, fashion houses, etc.

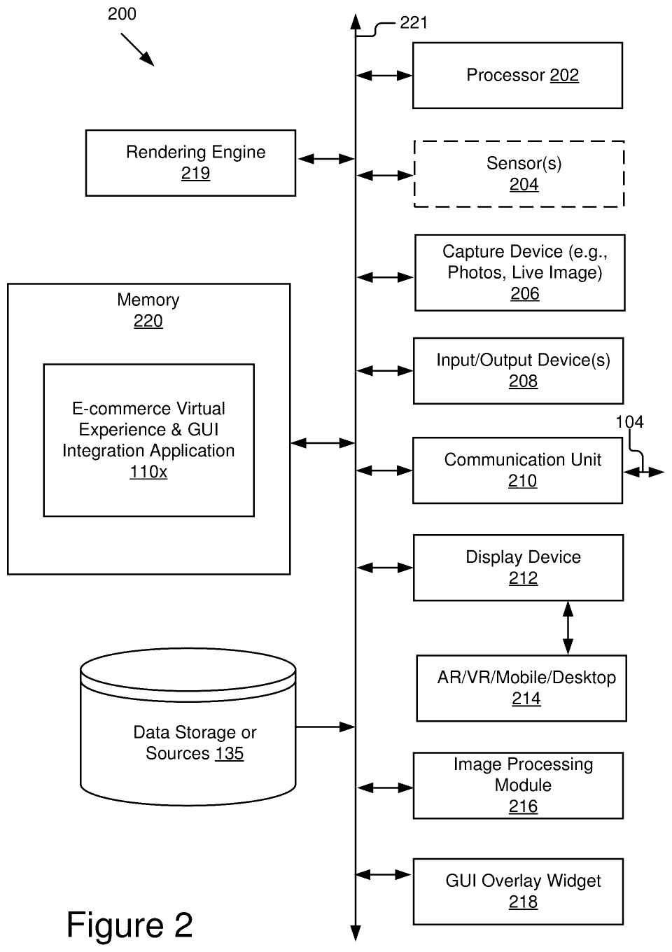

Referring now to FIG. 2, one implementation of the platform 120 including a e-commerce virtual and GUI integration system 110x is illustrated with example hardware and software components in a computing device 200. The computing device 200 may also include a processor 202, one or more sensors 204, capture device 206, an input/output device 208, a communication unit 210, a display device 212, which may include an augmented reality (AR) display, a virtual reality (VR) display, a mobile, desktop or the like, collectively illustrated at block 214, an image processing module 216, a GUI overlay widget 218, a rendering engine 219, a memory 220, coupled to the data storage or sources 135 The components of the computing device 200 are communicatively coupled by a bus 221. In some implementations, the computing device 200 may be representative of the client device 115, the platform 120, or a combination of the client device 115 and the platform 120. In such implementations where the computing device 200 is the client device 115 or the platform 120, it should be understood that the client device 115 and the platform 120 may take other forms and include additional or fewer components without departing from the scope of the present disclosure. For example, while not shown, the computing device 200 may include more sensors, capture devices, additional processors, and other physical configurations. Additionally, it should be understood that the computer architecture depicted in FIG. 2 could be applied to other entities of the system 100 with various modifications, including, for example, the servers 140 and data sources 135.

The processor 202 may execute software instructions by performing various input/output, logical, and/or mathematical operations. The processor 202 may have various computing architectures to process data signals including, for example, a complex instruction set computer (CISC) architecture, a reduced instruction set computer (RISC) architecture, and/or an architecture implementing a combination of instruction sets. The processor 202 may be physical and/or virtual, and may include a single processing unit or a plurality of processing units and/or cores. In some implementations, the processor 202 may be capable of generating and providing electronic display signals to the display device 212, supporting the display of images, capturing and transmitting images, and performing complex tasks including the image processing functions disclosed. In some implementations, the processor 202 may be coupled to the memory 220 via the bus 221 to access data and instructions therefrom and store data therein. The bus 221 may couple the processor 202 to the other components of the computing device 200 including, for example, the memory 220, the communication unit 210, the display device 212, the input/output device(s) 208, and the data storage 135.

The memory 220 may store and provide access to data for the other components of the computing device 200. The memory 220 may be included in a single computing device or distributed among a plurality of computing devices as discussed elsewhere herein. In some implementations, the memory 220 may store instructions and/or data that may be executed by the processor 202. The instructions and/or data may include code for performing the techniques described herein. For example, as depicted in FIG. 2, the memory 202 may store the e-commerce virtual and GUI integration application 110x. The memory 220 is also capable of storing other instructions and data, including, for example, an operating system, hardware drivers, other software applications, databases, etc. The memory 220 may be coupled to the bus 221 for communication with the processor 202 and the other components of the computing device 200.

The memory 220 may include one or more non-transitory computer-usable (e.g., readable, writeable) device, a static random access memory (SRAM) device, a dynamic random access memory (DRAM) device, an embedded memory device, a discrete memory device (e.g., a PROM, FPROM, ROM), a hard disk drive, an optical disk drive (CD, DVD, Blu-ray™, etc.) mediums, which can be any tangible apparatus or device that can contain, store, communicate, or transport instructions, data, computer programs, software, code, routines, etc., for processing by or in connection with the processor 202. In some implementations, the memory 220 may include one or more of volatile memory and non-volatile memory. It should be understood that the memory 220 may be a single device or may include multiple types of devices and configurations.

The bus 221 may represent one or more buses including an industry standard architecture (ISA) bus, a peripheral component interconnect (PCI) bus, a universal serial bus (USB), or some other bus providing similar functionality. The bus 221 may include a communication bus for transferring data between components of the computing device 200 or between computing device 200 and other components of the system 100 via the network 105 or portions thereof, a processor mesh, a combination thereof, etc. In some implementations, the e-commerce virtual and GUI integration application 110x and various other software operating on the computing device 200 (e.g., an operating system, device drivers, etc.) may cooperate and communicate via a software communication mechanism implemented in association with the bus 221. The software communication mechanism may include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication may be configured to be secure (e.g., SSH, HTTPS, etc.).

The display device 212 may be any conventional display device, monitor or screen, including but not limited to, a liquid crystal display (LCD), light emitting diode (LED), organic light-emitting diode (OLED) display or any other similarly equipped display device, screen or monitor. The display device 212 represents any device equipped to display user interfaces, electronic images, and data as described herein. In some implementations, the display device 212 may output display in binary (only two different values for pixels), monochrome (multiple shades of one color), or multiple colors and shades. The display device 212 is coupled to the bus 221 for communication with the processor 202 and the other components of the computing device 200. In some implementations, the display device 212 may be a touch-screen display device capable of receiving input from one or more fingers of a user. For example, the display device 212 may be a capacitive touch-screen display device capable of detecting and interpreting multiple points of contact with the display surface. In some implementations, the computing device 200 (e.g., client device 115) may include a graphics adapter (not shown) for rendering and outputting the images and data for presentation on display device 212. The graphics adapter (not shown) may be a separate processing device including a separate processor and memory (not shown) or may be integrated with the processor 202 and memory 220.

The input/output (I/O) device(s) 208 may include any standard device for inputting or outputting information and may be coupled to the computing device 200 either directly or through intervening I/O controllers. In some implementations, the input device 208 may include one or more peripheral devices. Non-limiting example I/O devices 208 include a touch screen or any other similarly equipped display device equipped to display user interfaces, electronic images, and data as described herein, a touchpad, a keyboard, a scanner, a stylus, an audio reproduction device (e.g., speaker), a microphone array, a barcode reader, an eye gaze tracker, a sip-and-puff device, and any other I/O components for facilitating communication and/or interaction with users. In some implementations, the functionality of the input/output device 208 and the display device 212 may be integrated, and a user of the computing device 200 (e.g., client device 115) may interact with the computing device 200 by contacting a surface of the display device 212 using one or more fingers. For example, the user may interact with an emulated (i.e., virtual or soft) keyboard displayed on the touch-screen display device 212 by using fingers to contact the display in the keyboard regions.

The communication unit 210 is hardware for receiving and transmitting data by linking the processor 201 to the network 105 and other processing systems via signal line 104. The communication unit 210 receives data such as requests from the client device 115 and transmits the requests to the e-commerce virtual and GUI integration application 110x, for example to view a garment of interest. The communication unit 210 also transmits information including media to the client device 115 for display, for example, in response to the request. The communication unit 210 is coupled to the bus 221. In some implementations, the communication unit 210 may include a port for direct physical connection to the client device 115 or to another communication channel. For example, the communication unit 210 may include an RJ45 port or similar port for wired communication with the client device 115. In other implementations, the communication unit 210 may include a wireless transceiver (not shown) for exchanging data with the client device 115 or any other communication channel using one or more wireless communication methods, such as IEEE 802.11, IEEE 802.16, Bluetooth® or another suitable wireless communication method.

In yet other implementations, the communication unit 210 may include a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still other implementations, the communication unit 241 may include a wired port and a wireless transceiver. The communication unit 210 also provides other conventional connections to the network 105 for distribution of files and/or media objects using standard network protocols such as TCP/IP, HTTP, HTTPS, and SMTP as will be understood to those skilled in the art.

The data storage 135 is a non-transitory memory that stores data for providing the functionality described herein. In some implementations, the data storage 135 may be coupled to the other components via the bus 221 to receive and provide access to data. In some implementations, the data storage 135 may store data received from other elements of the system 100 including, for example, entities 135 and 140 and/or the e-commerce virtual and GUI integration application applications 110x, and may provide data access to these entities. The data storage 135 may store data as described below in more detail.

The data storage 135 may be included in the computing device 200 or in another computing device and/or storage system distinct from but coupled to or accessible by the computing device 200. The data storage 135 may include one or more non-transitory computer-readable mediums for storing the data. In some implementations, the data storage 135 may be incorporated with the memory 220 or may be distinct therefrom. The data storage 135 may be a dynamic random-access memory (DRAM) device, a static random-access memory (SRAM) device, flash memory, or some other memory devices. In some implementations, the data storage 135 may include a database management system (DBMS) operable on the computing device 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations. In other implementations, the data storage 135 also may include a non-volatile memory or similar permanent storage device and media including a hard disk drive, a CD-ROM device, a DVD-ROM device, a DVD-RAM device, a DVD-RW device, a flash memory device, or some other mass storage device for storing information on a more permanent basis.

The computing device 200 also includes an image processing module 216 configured to create personalized avatars for users and facilitate the processing and display digital garments on the personalized avatar. The digital garments (and other fashion items) may be selected by the users or provided from a carousel of styled clothing by a recommendation engine described in greater detail. The computing device 200 also includes a GUI overlap widget 218, which is configured to display on top of a retailer's graphical user interface, allowing the user to interact with the retailer's website in conjunction with the GUI integration application of the present invention. These modules are disclosed in greater detail below.

It should be understood that other processors, operating systems, sensors, displays, and physical configurations are possible.

Referring now to FIG. 3, an example e-commerce environment illustrates the e-commerce virtual and GUI integration application 110x communicatively coupled with one or more retailer platforms with their digital presence accessible via websites or mobile applications. As illustrated, the retailer platforms include “Fashion Retailer 1,” “Fashion Retailer 2,” through “Fashion Retailer N.” The number “N” denotes that any number of retailers may be in the e-commerce infrastructure. The “Fashion Retailer 1” designated by reference numeral 318 may include “Retailer Inventory 1” designated by reference numeral 320, which is a partial or complete inventory of a retailer that is displayed in the retailer's digital store. As illustrated, the retailer 310 is a women's clothing store, and therefore, would have an inventory of women's garments from multiple brands. The garments and items of clothing may include, shirts, tops, dresses, skirts, and the like, as well as accessories, such as shoes, jewelry, sunglasses, bags and the like. To assist digital shoppers with selections, the retailer may have a recommendation/recommendations engine 322. As illustrated “Fashion Retailer 2,” illustrates, by way of example, a men's clothing digital store 324 with “Retailer Inventory 2,” referenced by numeral 326, which may include items of men's clothing and accessories, and a recommendation/recommendations engine 2, referenced by numeral 328. The notion of multiple digital stores in the e-commerce infrastructure is illustrated by “Fashion Retailer N” 330, shown as specializing in accessories, with a “Retailer Inventory N,” referenced by numeral 332 and a recommendation/recommendations engine N 334 retailer inventory through “Fashion Retailer N.” The e-commerce virtual and GUI integration application 110x communicatively couples with the retailer platforms 318, 324, and 330, and permits users to use its GUI overlay widget to elevate their shopping experience. The virtual-try on and GUI integration application 110x includes the image processing module 216 (FIG. 2) to drape garments selected over a shopper's personalized avatar as they digitally shop. The application 110x includes a set of machine learning models 302 for enabling e-commerce virtual of digital representations of real-world garments styled in conformity with a fashion standard. The machine learning models 302, may be trained in the manner described hereinafter, and include a segmentation generator 304, a garment warping model (M) 306, and a try-on synthesis model (M) 308. Once trained, the machine-learning models 302 are provided with input images received by a computer vision and machine learning pre-processing module 310 from the user application 110a-110n of the mobile device 115. As is described below, the computer vision pre-processing module 310 performs various checks on the received input images and executes various pre-processing operations, including generating features from the input images which are used by the machine learning models 302.

Based upon the pre-processed input image information generated by the computer vision and machine learning pre-processing module 310, the trained machine learning models 302 generate an image of a user wearing, in a user-selected style, a user-specified digital garment, e.g., a digital representation of a real-world garment, in a pose identified from the input image provided to the user application 110a-110n. A computer vision and machine learning post-processing module 312 is configured to post-process the image generated by the machine learning models 302 in order to, for example, detect if the generated image is of sufficient quality to be returned to the user of the mobile device 115. For example, the generated image may be evaluated by the post-processing module 312 in order to determine if the image features are not within a distribution of the images used during the machine learning training process. In certain embodiments the post-processing module 312 may be configured to perform other post-processing operations of the type described hereinafter.

As indicated above, given a front facing image of a user of the application 110a-110n and a garment image specified by the user via the application 110a-110n, the machine learning models 302 executed by the platform 120 synthesize a new image of the user wearing the target garment selected. In one embodiment the pipeline implemented by the machine learning models 302 does not alter the person's pose, the body shape or the person's identity. Users instead are, in some embodiments, encouraged to upload several various solo images of themselves in various different poses, hair styles, hats/headwear etc. via application 110a to allow them the option to transfer garment on to various different looks of themselves. In addition, the e-commerce virtual experience supports different styling options associated with a fashion standard to apply on the user-selected target garment; for example, the styling options for a target garment in the form of a blouse or shirt could include sleeves pushed up, sleeves cuffed, bodice tucked in, and so on, as contemplated by the fashion standard. As is discussed below, the available styles of the target garment may be defined within a digital styling taxonomy comporting with a fashion standard. To enable the machine learning models 302 to facilitate this style-aware e-commerce virtual process a set of style-aware garment datasets are generated in the manner described hereinafter. These style-aware datasets (436 in FIG. 4) may then be utilized in a subsequent machine learning training process. The trained machine learning models 302 may define an example digital style taxonomy including a plurality of styling combination categories conforming to a fashion standard, e.g., a high fashion standard. For example, a first styling combination category may include tops having the following styling segments: sleeves buttoned, half tucked, fully buttoned front portion and collar folded. There may be many options for the various styling segments included within the styling combination categories that may be stored in the database 135 (FIG. 2). For example, in some examples, a Sleeve Length styling segment may have potential length values of Wrist, Mid Hand and Fingers. As another example, a Bodice Fit styling segment may have potential fit values of Tight, Relaxed and Oversized.

Referring now to FIG. 4, the application software 110x includes, a styling variations module 402 to facilitate various styles as described here and a human body visual representation module 404 to create personalized avatars for users. FIG. 4 also includes, an interactive interface 406, a virtual closet 408, a real-time feedback module 410, a modification module 412, a product browsing module, a human body attributes carousel 416, styling endpoints 418, a generate combinations module 420 (single or multiple), and a e-commerce virtual 422 for single and multiple garments. FIG. 4 further includes a styler interface (e.g., visual indicia, a button etc.) 424, a synthesis module 426, a recommendation engine 428, machine learning (ML) data pipelines 430, a segmentation selection module 432, digital warping algorithms 434, and style aware datasets 436. In some implementations, a user can browse a retailer's product catalog directly from inside the styler interface 424. This mirrors the in-store experience of a sales associate bringing additional products to the fitting room, but the digital experience occurs instantaneously, and with quick access to a retailer's entire product catalog. From directly insider the styler interface 424, the user can click through and browse for new tops, bottoms, shoes, outwear, etc., and view them immediately represented on their own personalized shopper likeness. This fast processing of images can create millions of unique combinations of complete outfits. Retailers display their inventory to users globally via a graphical user interface, the overlay directly on top of their existing e-commerce storefronts. Users can exit the styler interface 424 and browse the retailer's digital storefront and return anytime. The styler interface 424 provides a more highly visual display of the retailer's products.

Referring now to FIG. 3 and FIG. 4 together, in some embodiments, a typical machine learning (ML) data pipeline 430 prepares the style aware datasets 436. The machine learning try-on/styling pipeline exposes try-on and styling endpoints 418. In one embodiment the learning try-on/styling pipeline includes three primary layers: a training layer, an evaluation layer and an inference layer. The training layer uses a style aware dataset 436 generated by the machine learning data pipeline 430 in order to train the machine learning models 302 (FIG. 3). In one embodiment the evaluation layer applies quantitative (structural similarity Index: SSIM, Perceptual similarity, F1-Score, Fréchet Inception Distance: FID) and qualitative evaluations to determine the checkpoint to promote for each of the machine learning models 302. The inference layer exposes the try-on and styling via API endpoints, it also includes a Try-On/Styling Orchestration logic, Pre/Post processing.

The machine learning data pipeline 430 may be configured to start by capturing a person's front facing image, a ghost garment image and PDP (product description page) text from a page of a website. In one embodiment this data capture is done using customized web crawlers: The information from each collaborating website will generally be obtained or captured to use the retailer assets on the website by a dedicated web crawler. This raw, captured data is cleaned, enriched and organized to be ready for large scale machine learning training. In one implementation the WebDataset standard is used as a standard utilizing in build the training dataset. The WebDataset is a PyTorch Dataset (IterableDataset) implementation providing efficient access to datasets stored in POSIX tar archives and uses only sequential/streaming data access. This advantageously brings substantial performance advantage in many compute environments, and is desirable and essential for very large-scale training.

Example embodiments of the machine learning data pipeline 430 do not use the raw garment and other web image data in the learning process. Rather, the raw data is first selected, manipulated, and then transformed into features to train the machine. In one embodiment the process of selecting from the raw, capture data results in exclusion of all corrupted images (e.g., images files that cannot be opened), person image with empty or unusable poses (e.g., poses with persons arms crossed), and all ghost images with an empty or invalid garment. Empty or invalid garment images include but are not limited to placeholder images that are included on websites when an item is no longer available and therefore does not show the intended garment. Also excluded during the selection process are person images with invalid segmentation (e.g., no top, top area height is larger than 70% of overall image height). Manipulation of the web image data may include resizing the captured images to a predefined pixel size, e.g., 1024×768.

In one embodiment the captured image data is transformed by generating a body semantic segmentation using QNet and Part Grouping Network (PGN) in accordance with techniques described in, for example, “Instance-level Human Parsing via Part Grouping Network”, Gong et al., ECCV 2018 and implemented on CIHP dataset. The transformation includes generating warped clothing for the try-on synthesis model using the best warping checkpoint. As used herein, the term “checkpoint” refers to a snapshot of a working model during the training process. The cloth-agnostic person image and cloth-agnostic person segmentation are then generated.

In some example embodiments, a correspondence between the target and source model may be calculated at this stage of the process. The correspondence between the target and source model is a fundamental step in this method, as it allows the system to warp and align a selected garment (source model) to the target model based on their unique body measurements and features.

Image correspondence in computer vision and machine learning refers to the process of identifying and matching the same features or points in two or more images.

The steps in establishing the correspondence in this method are detailed here. The first step is detection of a feature point and its description. In this step the goal is first to identify distinctive points (key points) in the images that can be easily recognized and matched across different images. The second step is, to create a descriptor for each keypoint that captures the local appearance or structure around the point. A deep learning method is used to simultaneously both detect the interest points and generate their descriptors. For example, one process, referred to as self-supervised interest point detection and description uses a single CNN to perform both interest-point detection and description tasks. The network is composed of two parts: an encoder, which extracts features from the input image, and two parallel decoders, one for detecting interest points and the other for generating descriptors. The network is trained using a self-supervised approach, eliminating the need for manual annotation. This model provides optimum results both in terms of the detection and description performance.

The next step is feature-matching and correspondence validation. In this step the goal is first to compare the descriptors from different images and identify the best matches. Subsequently, a validation method is used to remove incorrect matches or outliers. A deep learning-based method called “SuperGlue” known to those skilled in the art may be utilized at this stage. SuperGlue simultaneously performs context aggregation, matching, and filtering in a single end-to-end architecture. SuperGlue is a Graph Neural Network (GNN) that leverages both spatial relationships of the keypoints and their visual appearance through self- (intra-image) and cross- (inter-image) attention. The attention mechanisms used in SuperGlue are inspired by the success of the Transformer architecture. Self-attention boosts the receptive field of local descriptors, while cross-attention enables cross-image communication and is inspired by how humans look back-and-forth when matching images. In addition to SuperGlue, tiling may be used in some embodiments. For example, in some embodiments, images may be split up to maximize the key points generated. In this procedure (tilling) an image may be split into at least two parts, e.g., two or more parts. In some examples, each part may be the same size. In other examples, each part may be different sizes, as needed. By splitting an image into multiple parts, the number of key points generated may be increased. By reducing the size of the image, e.g., by splitting the imagine into at least two smaller images, each image may be processed more extensively and thus, the two images generate more meaningful points than the original image.

The correspondence established at this step is highly accurate and in one embodiment, returns a minimum of 300 corresponding keypoints. This high number of keypoints ensures that the TPS (Thin-plate spline) warping can accurately capture the intricate details of the garment and the target model's body shape. It also helps in accounting for the variations in fabric behavior, draping, and folding patterns, which are essential to create a realistic virtual try-on and styling experience. Some embodiments may be a realistic virtual try-on and luxury styling experience. Other embodiments may return 200 to 1000 keypoints, 100 to 2000 keypoints, or more keypoints. For example, some embodiments may return 100 to 3000 keypoints, 100 to 4000 keypoints, or more. In some embodiments, having a minimum of 300 key points allows the system to distribute the correspondences across the garment and the target model's body more evenly. This distribution ensures that the TPS warping covers a wide range of garment areas and body parts, accounting for different levels of detail and complexity. As a result, the warped garment will more accurately conform to the target model's body shape and exhibit a natural-looking fit. Additionally, this high number of keypoints contributes to the system's robustness against various challenges, ensuring a reliable and high-quality virtual try-on and styling experience standard for a digital representation of a real-world garment.

FIG. 4 further illustrates building the base web dataset and each specific version for the different machine learning models 302 (FIG. 3l. To build a dataset with a specific style conforming to a fashion standard (e.g., top sleeves pushed up, and tucked-in), images corresponding to the given style are identified from the entire base web dataset. In one embodiment this is a three-stage process. In a first stage, the training, test and evaluation datasets are built. In one embodiment this may be done using a taxonomy data tagging/labeling tool in the form of, for example, an internal instance of label studio with an already setup labeling project. This may involve utilizing experts to label a large number (e.g., on the order of 1000) of images of the target style. In a second stage the classifier is trained and the trained model is evaluated. If, based on the evaluation, it is determined that additional training data is required, then experts may be utilized to label a larger set of images of the target style. In a third “inference” stage, the style classifier is executed against the entire dataset and an appropriate styles classifier checkpoint is inferred. The output of this third stage is a ready to use fashion-aware dataset which may be used to train the virtual try-on pipeline for the target style. In an example implementation of a multi-class styles classifier which may be trained to recognize garment styles presented to it during a training process. The architecture of the classifier is based on the transfer learning technique for image classification. As used herein, the term transfer learning refers to an approach to machine learning in which a model developed for a task is reused as the starting point for a model on a second task. In one embodiment transfer learning is conducted in the present context using Visual Geometry Group (VGG19) with 19 CNN (Convolutional Neural Network) layers, trained with ImageNet dataset.

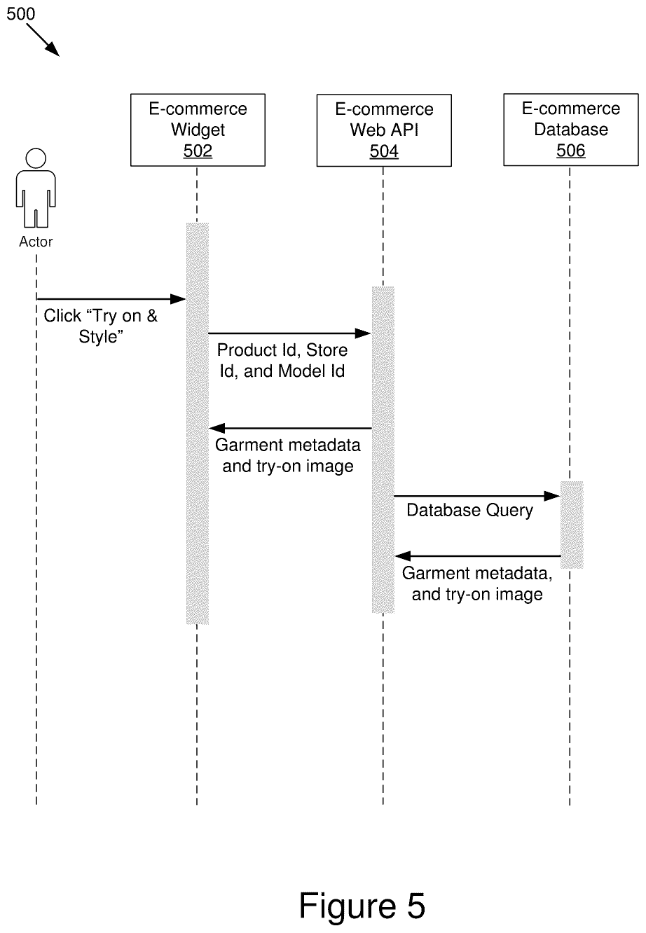

Referring now to FIG. 5, the process 500 by which the e-commerce widget interacts with a retailer's product catalog and the GUI integration system database illustrated. A user can select a garment via the graphical overlay while shopping in a retailer's or a particular brand's digital store. The graphical overlay, referenced here as “E-commerce widget” 502 delivers the entire experience to a shopper as a graphical overlay on top of an existing retailer's or brand's online presence, either mobile or desktop. Advantageously, the user does not need to download a new application software (App) or visit a third-party site. The unique graphical overlay integrates seamlessly with a retailer's or brand's digital presence. Moreover, the graphical overlay 502 is configured to communicate with the retailer's e-commerce website and to modify the user's experience as the user navigates the retailer's website. For example, users may add one or more products to the retailer's cart directly from the e-commerce widget 502. A user or actor (106a-106n) may click visual indicia, for example, a button or an icon provided within the graphical e-commerce widget to “Try On and Style.” This action by the user via the e-commerce widget 502 sends a query via to the e-commerce web application programming interface (API) 504 requesting product identification (ID), store identification (ID), and model identification (ID). The web API 504 sends a database query to the e-commerce database 506, which responds by transmitting the garment (or accessory etc.) metadata with a try-on image. The e-commerce web API 504 transmits the garment (or accessory etc.) metadata with try-on image to e-commerce widget 502, at which point the visual is presented to the shopper.

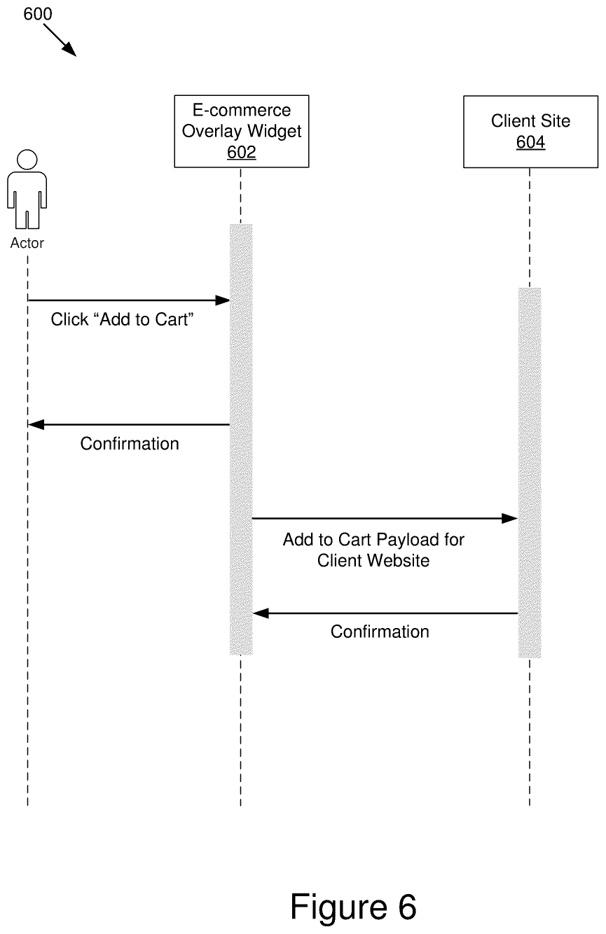

FIG. 6 illustrates the e-commerce widget of the present disclosure interacting with a retailer's shopping cart. The user or actor (FIG. 1, 106a-106n) may click visual indicia, for example, a digital button or icon to add a particular garment or style to retailer's shopping cart by clicking or pressing “Add to Cart” via the e-commerce overlay widget 602. That user's action triggers a add to cart payload function for the client's website 604 (representing a retailer or brand), which may provide a confirmation notification or signal, which is transmitted to the user to confirm that the function accomplished.

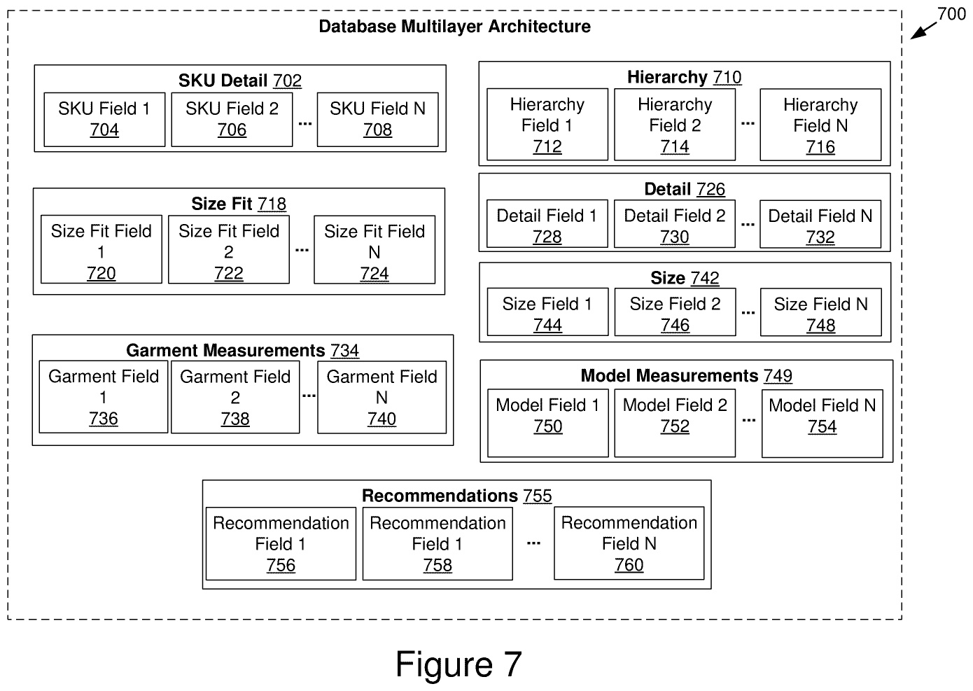

Referring now to FIG. 7, the database 506 in FIG. 5, referenced in this figure by reference numeral 700, has a multilayer architecture. The database 700 is configured to include categories to store data to enable response to a selection by a user. In some implementations, the data is obtained from collaborating e-commerce entities, for example, retailers, merchants, warehouses, fashion houses or the like. The data reflect e-commerce assets offered for purchase and related data. The illustrated embodiment includes SKU detail 702, with a number of fields, designated by labels, for example, “SKU Field 1,” (e.g., UPC) referenced by numeral 704, “SKU Field 2,” (e.g., SKU #) referenced by numeral 706, through “SKU Field N” referenced by numeral 708. Another category that is illustrated is “Hierarchy” referenced by numeral 710. This category may include separate fields of data, for example, “Hierarchy Field 1” (e.g., Brand) referenced by numeral 712, “Hierarchy Field 2” (e.g., Gender) referenced by numeral 714, through “Hierarchy Field N” (e.g., Category) referenced by numeral 716. The database 700 includes another category labeled “Size Fit” referenced by numeral 718. This category may include separate fields of data, for example, “Size Fit Field 1” (e.g., Closure Type) referenced by numeral 720, “Size Fit Field 2” (e.g., Sleeve Fit) referenced by numeral 722, through “Size Fit Field N” (e.g., Neckline) referenced by numeral 724. The database as illustrated includes a category with “Detail” referenced by numeral 726. This category includes “Detail Field 1” (e.g., Season) referenced by numeral 728, “Detail Field 2” (e.g., Weight) referenced by numeral 730, “Detail Field N” (e.g., Country of Origin) referenced by numeral 732. The database 700 includes another category including “Garment Measurements” referenced by numeral 734. This category 734 includes various fields, including “Garment Field 1,” (e.g., Chest Width (Bust)) referenced by numeral 736, “Garment Field 2,” (e.g., Waist) referenced by numeral 738, through “Garment Field N,” (e.g., Inseam) referenced by numeral 740. The database 700 includes another category labeled “Size” referenced by numeral 742. This size category 740 includes various fields on sizes, including “Size Field 1,” (e.g., Size) referenced by numeral 744, “Size Field 2,” (e.g., Size Scale Type) referenced by numeral 746, through “Size Field N,” (e.g., Size Region) referenced by numeral 748. Yet another category in the database 700 is “Model Measurements,” referenced by numeral 749. This category on model measurements may include multiple fields, including “Model Field 1,” (e.g., Height) referenced by numeral 750, “Model Field 2,” (e.g., Bust) referenced by numeral 752, through “Model Field N,” (e.g., Waist) referenced by numeral 754. The database 700 also has a category on recommendations 755, including various fields, for example, “Recommendations Field 1,” (e.g., Occasion) referenced by numeral 756, “Recommendations Field 2,” (e.g., Categories/Lifestyle) referenced by numeral 758, through “Recommendations Field N” referenced by numeral 760.

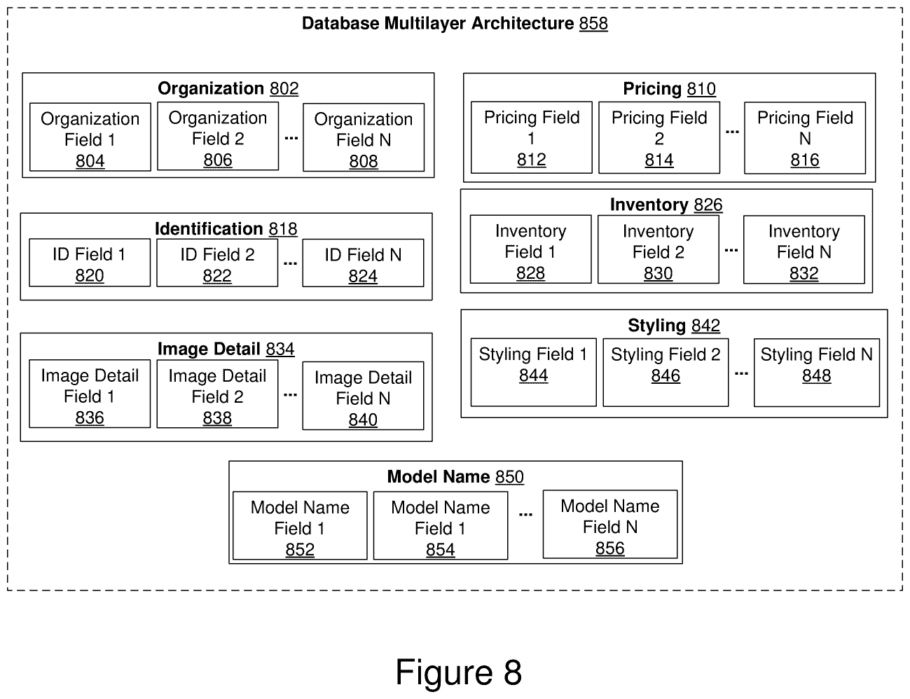

Referring now to FIG. 8, the database 506 in FIG. 5, referenced in this figure by reference numeral 800, has a multilayer architecture. The database 800 is configured to include categories to store data to enable response to a selection by a user. The illustrated embodiment shows “Organization” 802, with a number of fields, designated by labels, for example, “Organization Field 1,” referenced by numeral 804, “Organization Field 2,” referenced by numeral 806, through “Organization Field N” referenced by numeral 808. The illustrated embodiment includes data on “Pricing” 810, with a number of fields, designated by labels, for example, “Pricing Field 1,” referenced by numeral 812, “Pricing Field 2,” referenced by numeral 814, through “Pricing Field N” referenced by numeral 816. The illustrated embodiment shows yet another example category on “Identification” 818, with a number of fields, designated by labels, for example, “ID Field 1,” referenced by numeral 820, “ID Field 2,” referenced by numeral 822, through “ID Field N” referenced by numeral 824. The illustrated embodiment includes another category on “Inventory” 826, with a number of fields, designated by labels, for example, “Inventory Field 1,” referenced by numeral 828, “Inventory Field 2,” referenced by numeral 830, through “Inventory Field N” referenced by numeral 832. The illustrated embodiment includes another category “Image Detail” 834, with a number of fields, designated by labels, for example, “Image Detail Field 1,” referenced by numeral 836, “Image Detail Field 2,” referenced by numeral 836, through “Image Detail Field N” referenced by numeral 840. The illustrated embodiment includes “Styling” detail 842, with a number of fields, designated by labels, for example, “Styling Field 1,” referenced by numeral 844, “Styling Field 2,” referenced by numeral 846, through “Styling Field N” referenced by numeral 848. The database 858 includes another category with a number of fields, designated by labels, for example, “Model Name” with multiple fields including “Model Name Field” 850, “Model Nam Field 1,” referenced by numeral 852, “Model Name Field 2,” referenced by numeral 854, through “Model Name Field N” referenced by numeral 856.

The e-commerce system provides high-level representations of operation and training of a multi-class styles classifier implemented using the classifier architecture of the databases described here. The classifier is configured to assign a style (if applicable) to each image in the training data set. Specifically, a classifier determines, for each image in the data set, a probability of the image depicting a garment of a specific style. To avoid mislabeled data, a probability threshold Ptheshold is set above which it is determined, during a voting stage, that sufficient confidence exists to assign the matching style variation to the image. In one scenario, this is the situation represented, in which the probability associated with a particular “style A” was determined to exceed Ptheshold. If the voting step fails, the image is added to a parking lot accessible to experts capable of reviewing the unclassified image and assigning the correct label. The image may then be added to the training dataset of the style matching the correct label.

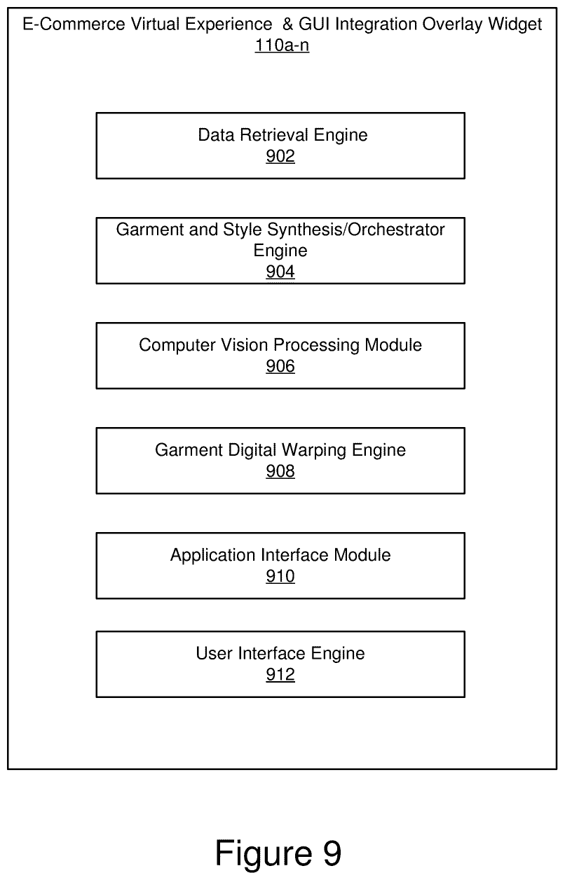

Referring now to FIG. 9, the virtual try-on overlay widget 110a-n, includes a data retrieval engine 902, a garment and style recommendation engine 904, a computer vision processing module 906, a garment digital warping engine 908, an application interface module 910, and a user interface engine 912. The data retrieval engine 902 is configured to retrieve the garment metadata and try-on image from the database (see FIG. 5) when a user clicks the “Try On & Style” interface option. The selection of a particular garment by the user may be obtained by a garment and style recommendation engine 904. The computer vision processing module 906 is coupled to process the try on image for display on the personalized avatar. The garment digital warping engine 908 uses the trained warping model (checkpoint) then deforms the garment based on the predicted segmentation as described above. The application interface module 910 serves as the defined interface for the graphical overlay and its interactive software to interact with other applications including retail applications, allowing them to request data, perform actions, or trigger events within that retailer's website. The user interface engine 912 facilitates the interaction between a user or consumer and the virtual try-on system, allowing the users to input commands and receive feedback through visual elements like buttons, menus, and text, essentially enabling users to interact with and control functions within the virtual try-one GUI overlay widget in a way that is intuitive and enhances the digital shopping experience.

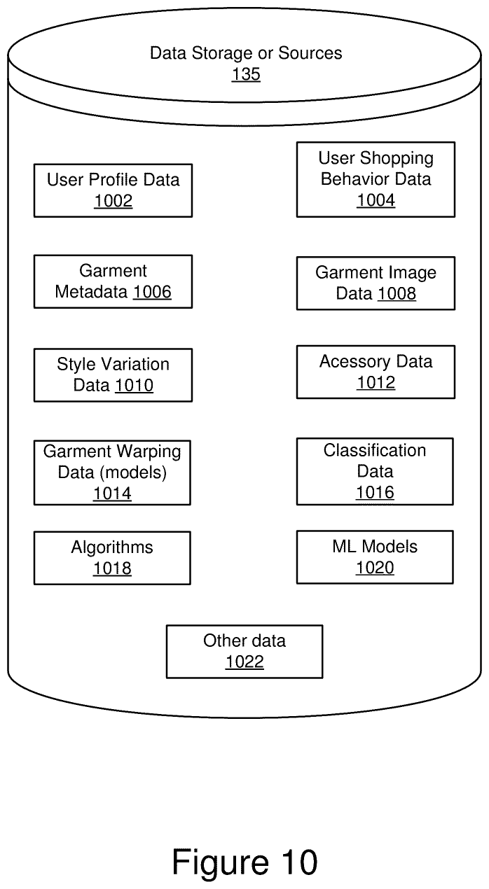

Referring now to FIG. 10, the data storage or storage 135 may store critical data sets, including user profile data 1002, which includes a collection of information that represents a user's identity and preferences within a particular retailer's (or merchant's) system or associated with the GUI widget 110a-110n. The user profile data 1002 may include details like personal information, account settings, customization options, and activity history, allowing the platform 120 or a retailer's platform to store and retrieve user-specific details for personalized digital shopping experiences. In some embodiments, the data storage 135 includes user shopping behavior data, which are compiled data sets on user shopping behavior patterns. These data sets may be used by the recommendation engine (FIG. 4) to make recommendations. The data storage 135 stores garment metadata 1006, garment image data 1008, style variation data 1010, and accessory data 1012. Versions of these data sets are also illustrated in FIGS. 7 and 8. The data storage 135 further includes garment warping data 1014, which includes the digital warping models utilized to file a garment image on a personalized avatar. The data storage 135 includes classification data 1016, for example data stored in accordance with the categories illustrated in FIGS. 7 and 8. The data storage 135 may include stored algorithms to perform the various functionalities here, including computer vision and machine learning algorithms to automatically detect and identify key landmarks or reference points on the user's body in both the garment image data and the personalized avatar. The algorithms include algorithms that map the user's body onto a virtual model, creating a personalized avatar that accurately represents the user's physique or shape. Other algorithms include simulation algorithms that account for fabric draping, stretching, and body movement to provide a realistic representation of how the clothing would appear on the user. The data storage 135 includes ML models 1020 that are the machine learning models disclosed here. Other types of data relevant are stored in other data repository 1022.

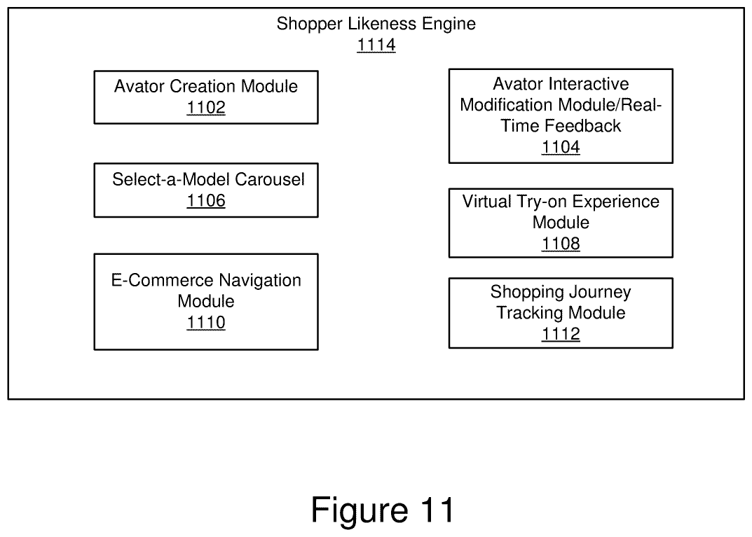

Referring now to FIG. 11, the shopper likeness engine 1114 is illustrated in further detail. The shopper likeness engine 1114 includes an avatar creation module 1102, which assists a user to create a personalized avatar. The shopper likeness engine includes an avatar interactive modification module with real-time feedback 1104, which provides continuous feedback for the user to meet the strict guidelines for creating the personalized avatar. A select-a-model carousel 1106 provides a display of many models so a user can select one similar in shape, ethnicity and other factors. A virtual try-on experience module 1108 facilitates the virtual try-on of garment images and an e-commerce navigation module 1110 allows a user to navigate a retailer's website or digital storefront with the personalized avatar. It should be recognized that the e-commerce system in accordance with the present invention includes one or more databases (e.g., distributed) that hold the data (assets) acquired from collaborating e-commerce entities. A shopping journey tracking module 1112 is configured to initiate and track the events relating to a user's path through a retailer's website. In some embodiments, the user may traverse several retailer websites (or other digital storefronts), select clothing items to self-curate a “look” or seek assistance from the recommendation engine 428 (FIG. 4) to curate an ensemble based on tracking the user's preferences. A user's life cycle of clothes change with time. The styler interface 424 may send a blast of recommended styles to the user in quick succession. The virtual try-on module 422 presents single clothing items or multiple ones, allowing the user to mix-and-match combinations, that may evolve with time.

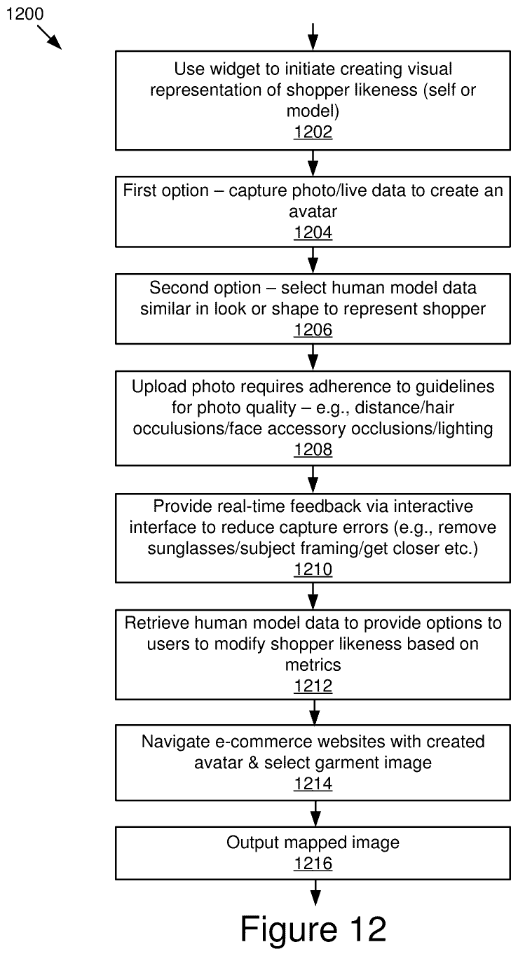

Referring now to FIG. 12, the process 1200 for creating a personalized avatar with “shopper likeness” begins at block 1202, including one or more operations for using the widget to initiate creating a visual representation a user, by using a photo of “self” or a human model that resembles the user or reflects the user's characteristics. This is referred to herein as developing “shopper likeness.” In some embodiments, the visual representation may be a photo. In some embodiments, the visual representation may be a live video. The process 1200 proceeds to the next block 1204, including one or more operations for presenting a first option to the user, by which the user can capture photo data to create a personalized avatar. The process 1200 proceeds to the next block 1206, including one or more operations for presenting a second option to the user, by which the user can select human model data similar in “look,” that is, appearance or shape to represent the user as the user navigates through e-commerce retail or brand websites. The process 1200 proceeds to the next block 1208, including one or more operations for uploading the photo to meet the strict guidelines required for photo quality. User characteristics including distance from the capture device, hair occlusions, face accessary occlusions, lighting etc., are considered. The process 1200 proceeds to the next block 1210, including one or more operations for providing real-time feedback via the interactive interface to reduce capture errors, for example, requesting the user to remove sunglasses or prescription glasses, framing the subject, requesting the user to get closer, etc. The process 1200 proceeds to the next block 1212, including one or more operations for retrieving human model data to provide options to users to modify “shopper likeness” based on physical metrics or characteristics. For example, in some implementations, a user is presented with different body shapes, sizes, heights, skin tones, ethnicities, hair colors, and ages, via a select-a-model carousel. In some implementations, a user is presented with different measurement options, on height, bust, waist, dress size, among other physical characteristics. These measurement options enable a user to select a human model that best matches their own body proportions. The select-a-models feature full body (head to toe) representations, to mimic the experience of viewing a full-length mirror to view all the elements of an outfit, for example, top, bottom, jacket, socks, shoes, and accessories. The process 1200 proceeds to the next block 1214, including one or more operations that enable a user to navigate one or more e-commerce websites with the user-created avatar and select a garment image from a retailer website to try on. The process 1200 proceeds to the next block 1216, including one or more operations for outputting a mapped image of the personalized avatar with the garment image displayed to the personalized avatar.

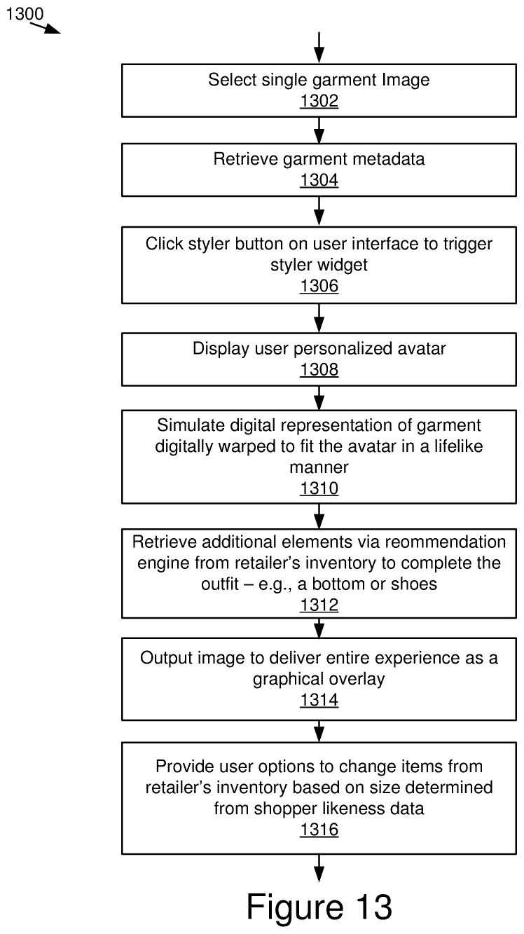

Referring now to FIG. 13, the process 1300 begins at a first block 1302, including one or more operations for selecting a single garment image. The process 1300 proceeds to the next block 1304, including one or more operations for retrieving garment metadata for the single garment image selected. The process 1300 proceeds to the next block 1306, including one or more operations for presenting a graphical interface option, referred to herein as “Style” visual indicia (e.g., button), which the user can click to trigger or activate the Styler widget. The process 1300 proceeds to the next block 1308, including one or more operations for displaying the user personalized avatar. The process 1300 proceeds to the next block 1310, including one or more operations simulating the digital representation of the single garment digitally warped to file the personalized avatar in a lifelike manner. The process 1300 proceeds to the next block 1312, including one or more operations retrieving additional elements via a recommendation engine from the retailer's inventory to complete the outfit, for example, with a bottom or shoes. The process 1300 proceeds to the next block 1314, including one or more operations for delivering an output image that delivers an entire experience as a graphical overlay, which can easily and seamlessly be integrated with a retailer's website. The process 1300 proceeds to the next block 1316, including one or more operations for providing user options to change clothing items from a retailer's inventory based on a size determined from the “shopper likeness” data.

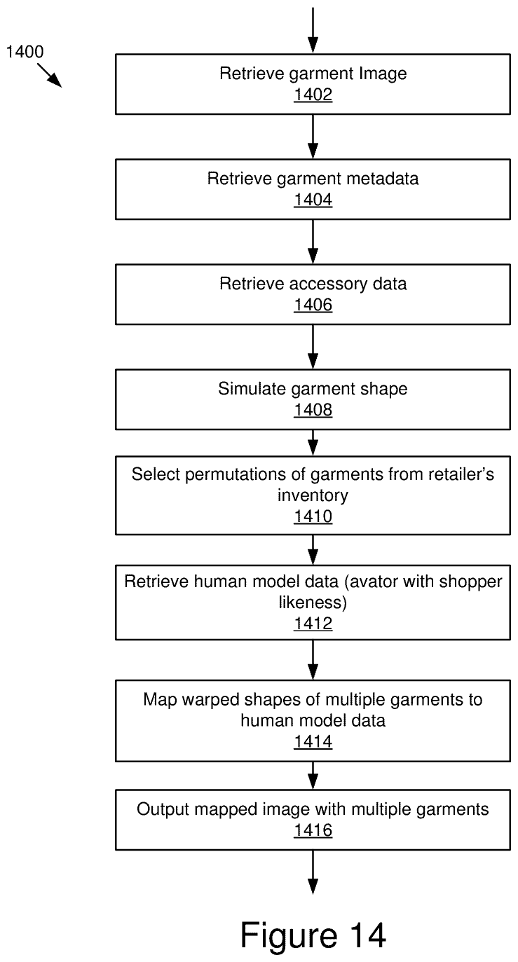

Referring now to FIG. 14, the process 1400 illustrates selecting multiple garments from a retailer's inventory. The process 1400 begins at block 1402, including one or more operations for retrieving garment images. The process 1400 proceeds to block 1402, including one or more operations for retrieving garment metadata. The process 1400 proceeds to block 1406, including one or more operations for retrieving accessory data. The process 1400 proceeds to the next block 1408, including one or more operations for simulating the garment shape. The process 1400 proceeds to the next block 1410, including one or more operations for selecting permutations of garments from a retailer's inventory. The process 1400 proceeds to the next block 1412, including one or more operations for retrieving human model data (avatar with shopper likeness). The process 1400 proceeds to the next block 1414, including one or more operations configured to map warped shapes of multiple garments to human model data. The process 1400 proceeds to the next block 1416, including one or more operations configured to output a mapped image with multiple garments.

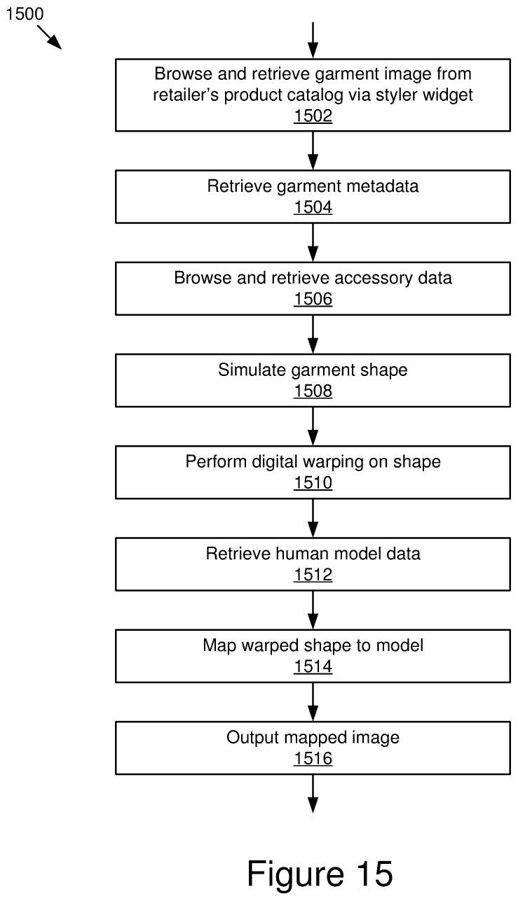

Referring now to FIG. 15, the process 1500 illustrates a user browsing for products on a retailer's website. The process 1500 starts at block 1502, including one or more operations for browsing and retrieving garment images of interest to a user from a retailer's product catalog via a styler widget. The process 1500 proceeds to the next block 1604, including one or more operations for retrieving garment metadata. The process 1500 proceeds to the next block 1506, including one or more operations for browsing and retrieving accessory data. The process 1500 proceeds to the next block 1508, including one or more operations for simulating garments. The process 1500 proceeds to the next block 1510, including one or more operations for performing digital warping on the shape of the garment. The process 1500 proceeds to the next block 1512, including one or more operations for retrieving human model data. The process 1500 proceeds to the next block 1514, including one or more operations for mapping the warped shape of the garment to the human model. The process 1500 proceeds to the next block 1516, including one or more operations for outputting the mapped image.

Turning now to FIGS. 9 and 10, an overview is provided of operation of an example machine-learning try-on/styling pipeline in accordance with the disclosure. The pipeline operates to receive from the user application 110a-110n, a front facing user photo, a selected garment to be digitally worn, and target garment styling options conforming to a fashion standard, e.g., high-fashion standard (via data retrieval engine 902). As described above, computer vision and machine learning pre-processing may be performed by determining the received photo meets person/pose requirements and an initial body segmentation and other features required by machine learning try-on/styling synthesis are generated. A try-on/styling orchestrator is responsible for routing all the inputs and the generated features to the appropriate machine learning try-on/styling instance (via garment and style synthesis/orchestrator engine 904). In one example implementation, the orchestrator has an internal factory that will instantiate the right machine learning models given the style. The orchestrator uses an internal map to determine the right machine learning models to use during the try-on process.

Models trained by machine learning may be used to execute try-on of garments styled in accordance with selected target styling options conforming to a fashion standard. In particular, a model may be used to predict, based on the selected garment and the initial body segmentation, the target area of the selected garment in the segmentation phase. The selected garment may be warped by using a trained model to deform the garment based on the predicted segmentation (via garment digital warping engine 908). A new image of the user wearing the selected garment may be synthesized by using a trained model to execute a garment transfer process based upon the selected target styling options conforming to a fashion standard, the predicted segmentation, and the warped garment. In one embodiment post-processing is performed to improve the machine learning output and detect, by performing segmentation, pose and anomaly detection if the synthesized image is of sufficient quality to be returned to the user for rendering on the user computing device. For example, once the corresponding key points between the source and target model is established, a non-affine transformation must be computed to warp the garment from the source model onto the target model. Non-affine transformations, as opposed to affine transformations, can handle more complex deformations, allowing for a better adaptation of the garment to the unique contours and features of the target model's body shape.

Thin-plate spline (TPS) warping is one such non-affine transformation technique that is commonly used for this purpose. The TPS transformation is a smooth, invertible mapping function that minimizes a certain bending energy, ensuring that the warped image remains smooth and does not introduce unwanted artifacts or distortions. To compute the TPS warping, the system first calculates the coefficients of the thin-plate spline function using the established key points correspondence. This involves solving a linear system of equations, which results in a set of coefficients that define the smooth mapping between the key points in the source and target domains. Next, the system applies the calculated TPS transformation to the entire garment image, not just the key points. This involves interpolating the transformation over the entire image, ensuring that the garment's pixels are smoothly warped onto the target model. This step is crucial for maintaining the visual integrity of the garment while adapting it to the target model's body shape.

An image inpainting technique is employed to eliminate any visible artifacts or imperfections in the overlaid garment. A diffusion-based inpainting method is utilized. This algorithm fills in the imperfections by considering the surrounding texture and color information, resulting in a more visually appealing output. An embodiment may use dynamic dilation masks. The dynamic dilation masks may be used to identify artifacts, imperfections, or both artifacts and imperfections that are missing.

The computer vision processing module 906 (FIG. 9) adjusts the colors, shading, and textures of the garment to ensure that it matches the lighting and appearance of the target model. It should be recognized that the systems and methods described herein also perform styling. This process involves lifting a styled garment from the source model to the target model. To ensure the accuracy and realism of this process, semantic tags are utilized on the correspondence garments. These tags indicate landmarks specific to particular styles of clothing and provide positional information about the garment on the source model. By identifying and utilizing these landmarks, semantic tags can guide the lifting and pasting of the garment onto the target model both in the try on and the post processing module of the pipeline. For instance, in a denim jacket, semantic tags can help identify landmarks such as the collar, cuffs, and hemline. Through the incorporation of these landmarks, a virtual try-on system can realistically model the behavior of the jacket on the target model, e.g., a real-world jacket on a real-world target model. This includes simulating details such as where the sleeves would naturally push up when rolled or how the hemline would move when the jacket is half-tucked. By accurately representing these details, the virtual try-on system can create a more immersive and believable try-on experience for the user.

For example, in one example try-on/styling workflow in accordance with the disclosure, segmentation generators (304, FIG. 3) may be implemented using a generative adversarial network (CAN) with, for example, a convolutional neural network such as a U-Net Generator and multi-scale patch discriminators. See, e.g., “U-Net: Convolutional Networks for Biomedical Image Segmentation”, Ronneberger et al., arXiv:1505.04597v1 [cs.CV]18 May 2015. The try-on/styling workflow utilizes machine learning models to implement segmentation, garment warping, and try-on operations. For example, once the garment has been warped to fit the target model (by garment digital warping engine 908), the computer vision processing module 906 overlays the garment onto the target model image or personalized avatar. This step involves blending techniques to seamlessly integrate the garment with the target model or personalized avatar, ensuring a realistic appearance.

The system performs post-processing steps (described in FIG. 3) to refine the visual output further. This process includes several techniques to enhance the final results. For example, fine tuning the garment fit. To eliminate any imperfections in the overlaid garment an iterative refinement technique is utilized. This method iteratively adjusts the warped garment until the overlaid error falls below a predefined threshold. In some implementations, the iterative refinement process begins by calculating the error between the overlaid garment and the target model. This error is quantified by subtracting the target model upper body segmentation from the warped garment mask. During each iteration, the system identifies regions in the overlaid garment that contribute to the error and makes appropriate adjustments. These adjustments involve re-warping the garment locally and modifying the blending weights. The error is then recalculated, and the process repeats until the error falls below the specified threshold or a maximum number of iterations are reached. A U-Net architecture of a type useful in implementing the segmentation generators (304, FIG. 3) may be utilized in the try-on/styling workflow. A principal objective of the model implemented by segmentation generators is to predict the area of the target garment in the person body segmentation. In inference mode, the inputs to this model are: (i) the cloth-agnostic segmentation; (ii) the person pose; (iii) the cloth; (iv) the cloth mask. During training, the images (assets from collaborating websites, for example retailers) are used to build the cloth agnostic image of the person wearing the target garment, where the ground truth is the person segmentation.

The machine learning model for garment digital warping (908) may be implemented using an architecture comprised of a Geometric Matching Module (GMM) with Thin Plate Spline (TPS). This architecture is described in, for example, in “Toward Characteristic-Preserving Image-based Virtual Try-On Network”, Wang et al., arXiv:1807.07688v3 [cs.CV]12 Sep. 2018. The model implemented for garment warping predicts the garment deformations to fill the target body part in the person segmentation. In one embodiment, the model relies on a grid (e.g., 12×16). This grid is used in order to have a sense of the deformation using the grid key points (e.g., 192 points). During training, the model for garment warping takes the ghost images with no deformation (FIG. 13C), the person pose and segmentation. In this case the ground truth is the garment extract from the person wearing it. The garment is extracted using the person semantic segmentation.

In one example embodiment, garment extraction may be performed. For example, users select garments from a pre-existing database provided by the retailer. In one example, a deep learning-based segmentation technique, such as in Gong, Ke, Xiaodan Liang, Yicheng Li, Yimin Chen, Ming Yang, and Liang Lin. “Instance-level Human Parsing Via Part Grouping Network” in Proceedings of the European conference on computer vision (ECCV), pp. 770-785. 2018, may be employed to accurately separate the garment from the background and the source model.

In one embodiment, the machine-learning model for try-on synthesis (904) may be implemented using an architecture comprised of a generative adversarial network (GAN) with a pix2pixHD generator and multi-scale patch discriminators. Pix2pixHD is a method for synthesizing high resolution photo-realistic images from semantic label maps using conditional generative adversarial networks (CGANs). See, e.g., “High-Resolution Image Synthesis and Semantic Manipulation with Conditional GANs”, Wang et al., arXiv:1711.11585v2 [cs.CV]20; August, 2018. In order to improve the overall result, the perceptual loss (based a pre-trained VGG16) may be used to ascertain the overall loss function. See, e.g., “Perceptual Losses for Real-Time Style Transfer and Super-Resolution”; Johnson et al., arXiv:1603.08155v1 [cs.CV]27; March, 2016.

In one embodiment the model for try-on synthesis is executed as a final step in completing the try-on/styling process. The model for try-on synthesis operates utilizing the output of the previous models; that is, a generated segmentation and warped garment. The model additionally utilizes the initial cloth-agnostic segmentation and pose.

In one embodiment the platform 110 further includes a digital garment recommendation engine and an outfit/fashion recommendation engine configured to function with the user application 110 to facilitate recommendation of digital garments, e.g., digital representations of real-world garments. The digital garment recommendation engine enables a user to wear a digital garment in the manner described above. The digital garment may be stored within a digital closet for the user maintained by the user by platform 110 during the duration of a shopping experience, when the user is seeking multiple outfits. During this shopping term the user may submit, via the user application 110, different images of the user to the platform 120 (FIG. 1) and in response receive versions of the different images in which some or all of the user's clothing within the submitted images is replaced by different digital garments.

In some instances, the recommendation engine can also enable users to create a fashion list of desired items. For example, from a basket of item(s) the user “shuffles” all permutations into a variety of styling and/or complete outfits which the user may rank and/or like to indicate user preferences. Based on rank order the system adds selected item(s) and/or styling choices to the shuffle basket. The resulting permutations, ensembles, individually styled item(s) and/or outfits can be tagged by use-case and user-generated keywords. Users can “save” item(s), individually styled item(s), ensembles and/or outfits and have the ability to share them with others via social media platforms. Users can also remove items of clothing from their digital closets. User-generated metadata and ranking is used to improve metadata and recommendations and create rank order “most popular” individually styled item(s) ensembles and/or outfits that can be further up-voted by the user community. Subtle semantic metadata can be gleaned from user keywords including mood, use case, style, demographic, psychographic, and other explicit and implicit factors.

The outfit/fashion recommendation engine may enable outfits to be selected and recommended based on a user's mood. The metadata schema categorizes clothing by use cases taxonomy and emotional vector valence. Via user input, ensembles are assembled based on the use case taxonomy, mood and mood intensity. Users rank order recommendation results to improve precision of subsequent recommendations. Interactive environments are in need for believable characters. Their personality and emotions should affect the behavior in order to increase the emotional immersion of the player. In one proposed model, virtual characters (or agents) are equipped with an individual personality and dynamic emotions. Both models interact within the selection of appropriate actions, and are thus central for the exhibited behavior of autonomous agents. The proposed model is application-independent and allows to render a rich set of behaviors for virtual characters in learning environments. See, e.g., “Emotional Agents for Interactive Environments”; Masuch et al.; 4th Int. Conf. on Creating, Connecting and Collaborating through Computing (C5 2006), Jan. 26-27, 2006, Berkeley, California.

A typical pipeline involves a plurality of steps. For example, step 1 within the pipeline is a photo shoot. The user provides a photo of self. Step 2 within the pipeline is asset generation. Step three within the pipeline is multi-stage warping. Step 4 within the pipeline is post processing. Each of the steps involve sub-steps within a pipeline in accordance with the systems and methods described herein. In some embodiments, the photo shoot may include capturing initial undergarment shots and/or reference. In an example embodiment, capturing initial undergarment shots and/or reference may be for all selected models. A reference shot may refer to a photograph taken as a visual reference or guide for a specific purpose. The reference shot may serve as a benchmark or template that the systems and methods described herein may refer back to as a reference. The reference shot may be a shot of a model (or models) in undergarments.

The photo shoot may include taking one or more correspondence shots. The correspondence shots may align to the reference shot. For example, in some embodiments, the correspondence shots may align to the reference shot for all selected models. The correspondence shot may be a type of photograph that captures a subject from different angles, distances, or perspectives. The correspondence shot may involve taking multiple shots of the same subject, and may include varying the composition, framing, or camera settings between each shot. The correspondence shots may provide a range of options for selecting the most visually appealing or compelling image from the series. By experimenting with different angles, perspectives, and settings, photographers may explore creative possibilities and find the best representation of the subject.

The photo shoot may include taking one or more cloth shots aligning to the reference shot source model only. A cloth shot may refer to a photograph that focuses primarily on showcasing a particular item of clothing or fabric in the event it is critical to capture detail. The cloth shot may be a close-up or detailed shot that may highlight the texture, pattern, design, or other unique features of the cloth. When capturing a cloth shot, the photographer may aim to capture the essence and visual appeal of the fabric. This may involve zooming in on the fabric to reveal intricate details, emphasizing the texture by using lighting techniques, or capturing the fabric in a way that highlights one or more of the fabric's drape, flow, or movement. Cloth shots are commonly used in various fields such as fashion photography, textile industry, product catalogs, and advertising. The cloth shot may serve the purpose of showcasing the quality, craftsmanship, and aesthetic aspects of the fabric, enabling viewers to get a closer look at its characteristics. By focusing on the cloth itself, a cloth shot may communicate information about the material, color, pattern, and overall style. The cloth shot may allow viewers to assess the fabric's visual appeal, texture, and suitability for different purposes or fashion applications. The cloth shot in a photo shoot may refer to a specialized photograph that highlights the unique qualities of a fabric, allowing viewers to appreciate the fabric's details, texture, and overall aesthetic appeal.

Each of the shots, e.g., the reference shots, the correspondence shots, the cloth shots, or some combination of the reference shots, the correspondence shots, and the cloth shots may be stored in the databases described here. The database may be stored on various types of hardware depending on the specific requirements and scale of the database system. Some common types of hardware used to store databases include servers, Storage Area Networks (SAN), Solid-State Drives (SSDs), Redundant Array of Independent Disks (RAID), cloud storage, or some combination of servers, SAN, SSDs, RAID, and cloud storage. While databases may be stored on hardware, each database may be managed and accessed through a database management system (DBMS) software, which provides the interface for interacting with the data stored on the hardware infrastructure.

In an example embodiment color coding may be used with respect to key points in the pose. For example, red may indicate misaligned key points and green may indicate aligned key points. Dots may be used to illustrate misalignment and alignment. For example, in color photos, a red dot may indicate misalignment and a green dot may indicate alignment. Additionally, in the illustrated examples here, the silhouette of the initial reference shot may be overlaid on the preview. The silhouette of the initial reference shot may provide better overall alignment guidance. Various photographs (shots) of a source model (personalized avatar) in a photo shoot, include a reference shot, a correspondence shot, and a cloth shot. The reference shot, the correspondence shot, and the cloth shot are defined. Various photographs (shots) of a target model (personalized avatar) in a photo shoot, include a reference shot and a correspondence shot. Misalignment issues between the models may occur. For example, misalignment issues between the models and a cloth overlay. In some example embodiments alignment may be performed manually. For example, some example embodiments may use manual alignment through the data pipeline. In such an example, a person operating the system may manually align the shots.

In a virtual try-on system, manual alignment of a shot may refer to the process of manually adjusting or aligning a virtual garment or accessory, or manually adjusting or aligning a virtual representation of a person with, e.g., a reference shot of a model. In an example, a corresponding user's body in a captured or uploaded image or video. The manual alignment may involve carefully positioning and matching the virtual item (or model) with the user's or model's body landmarks or reference points to create a realistic and accurate virtual representation.

Steps may include User Image Acquisition, Landmark Detection, Virtual Garment Placement, Fine-Tuning and Refinement, Real-Time Visualization. By performing manual alignment of a shot in a virtual try-on system, the aim is to create a seamless integration of the virtual garment or accessory with the user's image or video, providing an accurate representation of how the clothing item would look on the user.

In other example embodiments, a computing system may compare two or more shots and perform an automated alignment. Automated alignment of two shots in a virtual try-on system may refer to the process of automatically aligning a virtual garment or accessory with the user's body in two separate images or videos. Automated alignment may involve utilizing computer vision (906) and image processing techniques to analyze and align the virtual item with the user's body in a consistent and accurate manner (or aligning a pose of a second model, e.g., the user with a first model, e.g., a reference model). Machine learning may also be used to analyze and align the virtual item with the user's body in a consistent and accurate manner.

Automated alignment may include landmark detection, where the system may use computer vision and machine learning algorithms to automatically detect and identify key landmarks or reference points on the user's body in both images and/or videos. These landmarks may act as anchor points for alignment. The system may perform feature matching where the system analyzes the features of the virtual garment and the user's body in both images or videos and identifies common features or patterns that can be matched between the two sets of data. The system may also perform transformation estimation based on the matched features and detected landmarks, the system estimates the necessary transformations, such as translation, rotation, and scaling, to align the virtual garment with the user's body. Some example embodiments may perform alignment adjustment. The estimated transformations may be applied to the virtual garment to align it with the user's body in the second image or video. This adjustment ensures that the virtual garment maintains consistent positioning and proportions across the two shots. An example embodiment may perform real-time visualization. The system provides real-time visualization of the aligned virtual garment, allowing the user or operator to see how it fits on the user's body in the second image or video. This visualization aids in assessing the alignment quality and making any necessary refinements. Automated alignment in a virtual try-on system may reduce the need for manual intervention and streamlines the process of aligning virtual garments with the user's body. By leveraging computer vision and machine learning techniques, it enables efficient and accurate alignment, providing users with a realistic and personalized virtual try-on experience.

Other example of steps and sub-steps within a pipeline in accordance with the systems and methods described herein, may include sub-steps such as segmentation, a self-correction for human parsing (SCHP) model may provide crude body/garment segmentation, a determination may be made that an intersection over union (IOU) between SCHP segmentation and segment anything model (SAM) masks is greater than a threshold. When the IOU between SCHP segmentation and the SAM masks are greater than a threshold, the SAM generated masks and masked images may be stored in the database. SAM generates all possible object masks. The system may perform correspondence generation, correspondence may be determined between source and all other models. The system may also perform custom filtering on correspondence points. Correspondence key points may be in a NumPy array.

IOU may be used as a metric in computer vision (906), including virtual try-on systems. IOU may be used to measure the overlap between two bounding boxes or regions of interest. For example, IOU may be used to evaluate the accuracy of the virtual garment's alignment with the user's body. IOU may quantify how well the virtual garment aligns with the corresponding region of the user's body in terms of spatial overlap.

IOU may be calculated using a Bounding Box Definition, an Intersection Calculation, a Union Calculation, or a IOU Calculation. An example formula for IOU is:

IOU=Intersection Area/Union Area. The IOU score may range from 0 to 1, with a score of 1 indicating a perfect alignment or complete overlap between the virtual garment and the user's body. A higher IOU score signifies a better alignment and a closer fit of the virtual garment to the user's body.

Self-Correction for Human Parsing (SCHP) is a body-part and garment segmentation model which provides semantic labels and segmentation masks for person images. (See Li, Peike, Yunqiu Xu, Yunchao Wei, and Yi Yang. “Self-correction for human parsing.” IEEE Transactions on Pattern Analysis and Machine Intelligence 44, no. 6 (2020): 3260-3271.) However, its masks are crude and often inaccurate.

Segment Anything Model (SAM) is another segmentation model that only provides segmentation masks for objects, including persons. (See Kirillov, Alexander, Eric Mintun, Nikhila Ravi, Hanzi Mao, Chloe Rolland, Laura Gustafson, Tete Xiao et al. “Segment anything.” arXiv preprint arXiv:2304.02643 (2023).) SAM provides accurate object masks but it does not provide semantic labels for object masks. By incorporating SCHP guidance with SAM, this improves the localization of objects while providing semantic labels to them.

An example of steps related to segmentation in accordance with the systems and methods described herein may involve the user of the SCHP model to provide crude body and/or garment segmentation. A determination may be made that the IOU between the SCHP segmentation and SAM masks is greater than a threshold. SAM may generate all possible object masks. The SAM generated masks and mask images may be stored in the databases described here. In some implementations, segmentation with SCHP-guided SAM may be used. Segmentation may be used to identify which pixels in an image correspond to specific predefined labels. Correspondence generation may also be used. In virtual try-on, correspondence refers to the process of establishing a meaningful relationship or association between the virtual garment and the user's body or image/video (personalized avatar). Correspondence involves identifying and aligning specific points or regions of the garment with the corresponding points or regions on the user's body. The correspondence between source and all other models may be determined. Custom filtering on correspondence points may be performed. Custom filtering in correspondence for virtual try-on may refer to a technique or process that allows for the customization and refinement of the correspondence between the virtual garment and the user's body. The filtering may involve applying specific filters or adjustments to improve the accuracy and quality of the alignment. The correspondence keypoints may be stored in a database, e.g., using a numpy array. A Numpy array is a fundamental data structure in the NumPy (Numerical Python) library, which is a popular package for numerical computations in Python. A NumPy array, also known as ndarray, is a multi-dimensional container that stores elements of the same data type in a contiguous block of memory.

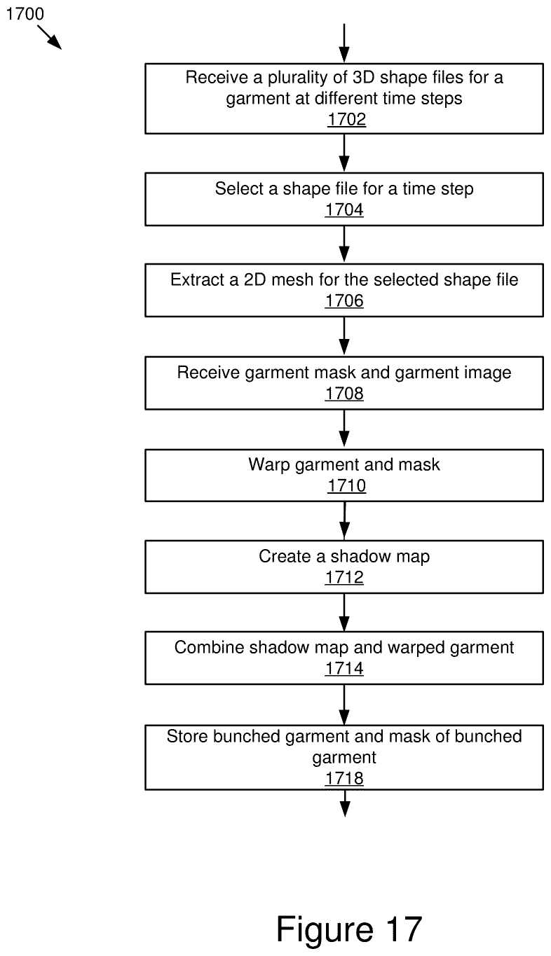

Referring now to FIG. 17, the process 1700 illustrates an embodiment including machine learning steps for presenting a garment image. The process 1700 begins at block 1702, including one or more operations for receiving a plurality of shape files (e.g., 3D) for a garment at different steps. The process 1700 proceeds to the next block 1704, including one or more operations for selecting a shape for each time step. The process 1700 proceeds to the next block 1706, including one or more operations for extracting a 2D mesh for the selected shape file. The process 1700 proceeds to the next block 1708, including one or more operations for receiving the garment mask and garment image. The process 1700 proceeds to the next block, including one or more operations for 1710 for warping the garment and mask. The process 1700 proceeds to the next block 1712 including one or more operations for creating a shadow map. The process 1700 proceeds to the next block 1714 including one or more operations for combining the shadow map and warped garment. The process 1700 proceeds to the next block 1718 including one or more operations for storing bunched garment and mask of bunched garment 1718.

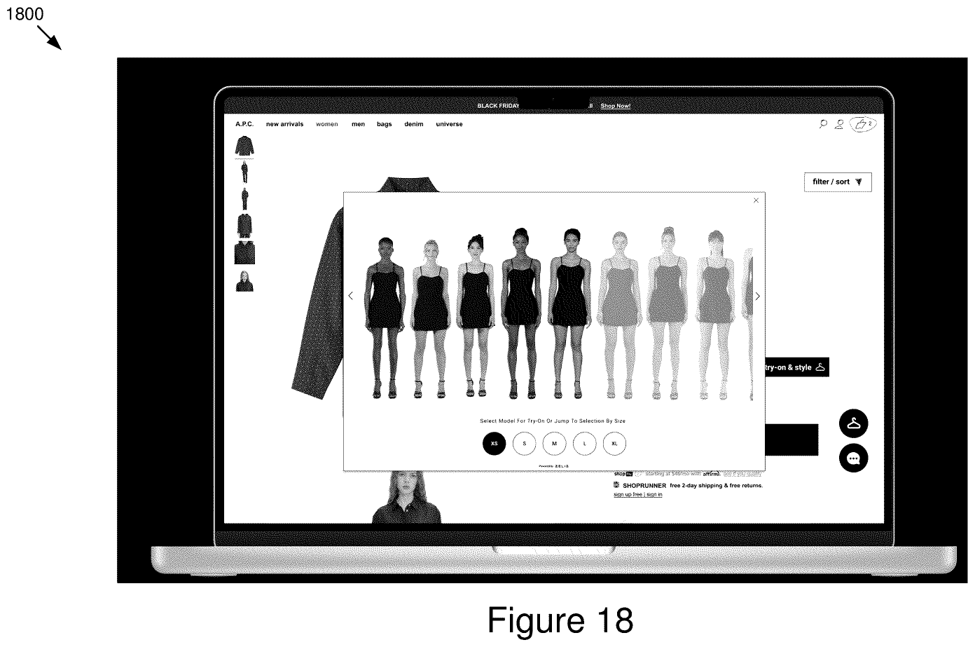

FIGS. 18-33 are graphical user interface (GUI) overlay displays generated by the virtual try-on and GUI integration system described herein and displayed on top of the retailer's graphical user display viewed by a consumer or user. FIG. 18 illustrates a graphical user interface (GUI) display 1800 showing options presented to consumers or users before they begin their online shopping experience, to create their human body presentation or personalized avatar (to create “shopper likeness”). The GUI display 1800 shows an array of human body models by a select-a-model function that appears in the foreground of the GUI display 1800. The GUI display 1800 also includes a GUI option that allow a consumer or user to select a model as a visual representation for the e-commerce journey and try-on or proceed to selection via indicating a size. The size categories displayed include “XS” for an extra-small size, “S” for a small size, “M” for a medium size, “L” for a large size, and “XL” for an extra-large size. The background in the GUI display 1800 displays retailer display options, for example, a retailer or brand name, standard categories such as “new arrivals,” “women,” “men,” “bags,” “denim,” “universe,” a filter/sort function, identification of a shopping event, for example “BLACK FRIDAY,” and an invitation to “Shop Now,” which a user can click to start shopping.

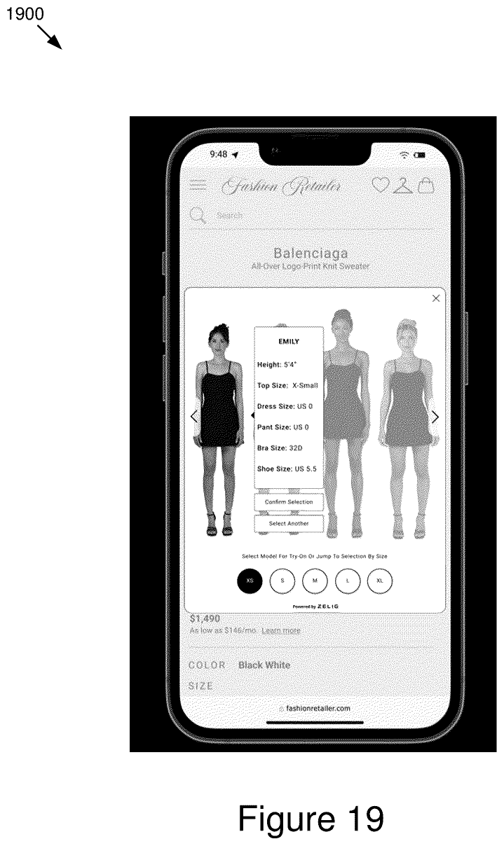

FIG. 19 illustrates another GUI overlay display 1900 showing the specific body metrics for a particular user identified by name, for example “EMILY.” This user metrics including, height, top size, dress size, pant size, bra size, and shoe size are indicated with an option to confirm selection of the user's personalized avatar or human body representation or to select another. The option to select a model for try on or jump to selecting by size is displayed at the bottom.

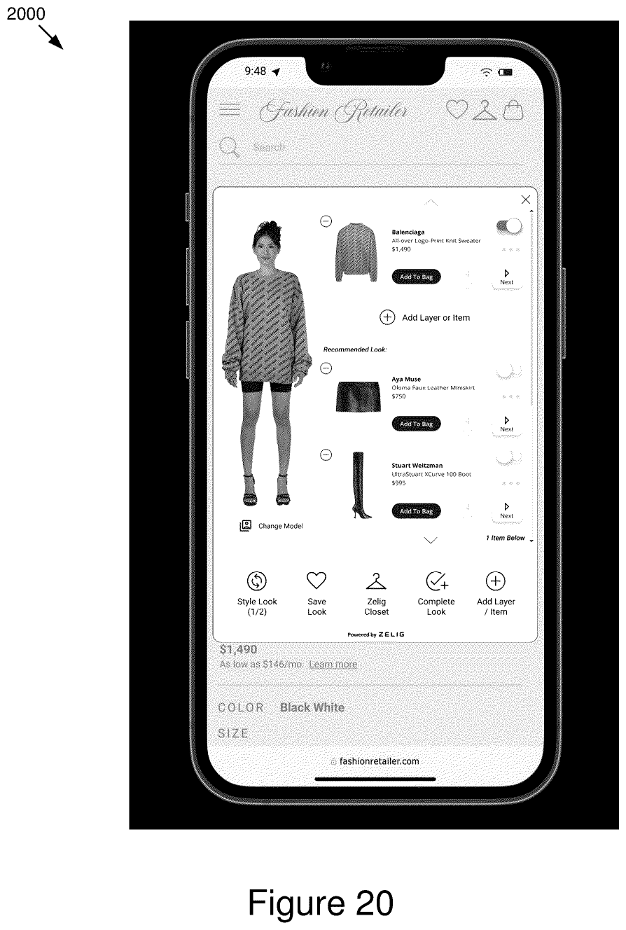

FIG. 20 illustrates GUI overlay display 2000 of a particular fashion brand, with display of the selected human body representation or personalized avatar and various types of garments, for example, a top, a miniskirt, and boots offered for sale by the retailer. Beside each garment type there is option to add the “bag” or cart. To facilitate the virtual try-on experience, a consumer or user can click an option to “style look,” by which each garment selected is displayed worn by the personalized avatar. The option “style look” may style variations offered from a team of expert stylists for each garment or outfit or a style as determined by the user, by another stylist, by an artificial (AI) stylist. Other GUI display options include an option to “save” the look, which is saving a combination of clothing (e.g., a “look”) in a virtual try-on system in accordance with the systems and methods described herein. Combinations of clothing also referred to as a look, may be saved so that the look may be referred to later. Another option is a virtual “closet” to save a particular look for later consideration or purchase, a complete look function to indicate that the user has completed viewing a desired outfit, and an option to add a layer of item or garment.

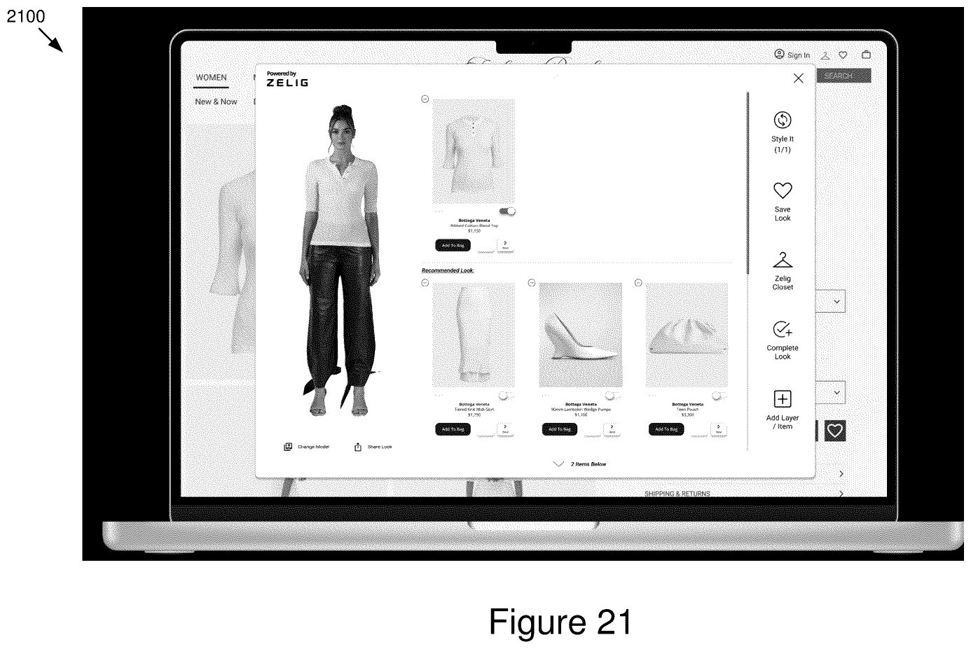

FIG. 21 illustrates a GUI overlay display 2100 illustrating garment types, for example a top and skirt, and accessories including shoe and a bag to “Complete the look.” The feature “Complete the look” may automatically place the recommended outfit on the selected model or image and default to styling recommendations in certain instances. The options to change the model or share the look are also displayed with the other options described above. A desktop styler sizes in accordance with the systems and methods described herein may run on a laptop computer, desktop computer, or other computing platforms. The desktop styler may come in many different sizes, including a small desktop styler, a medium desktop styler, and a large desktop styler. A small desktop styler in accordance with the systems and methods described herein may include features such as seeing items tried on in a condensed format and maximizing to medium styler. A medium desktop styler in accordance with the systems and methods described herein may include features such as styling variations, adding items to a bag, adding outfits to saved looks, minimizing to the smaller styler, and maximizing to the larger styler. A large desktop styler in accordance with the systems and methods described herein may include features such as styling variations, adding items to a bag, adding outfits to saved looks, and minimizing to the medium styler as well as filtering recommended products.

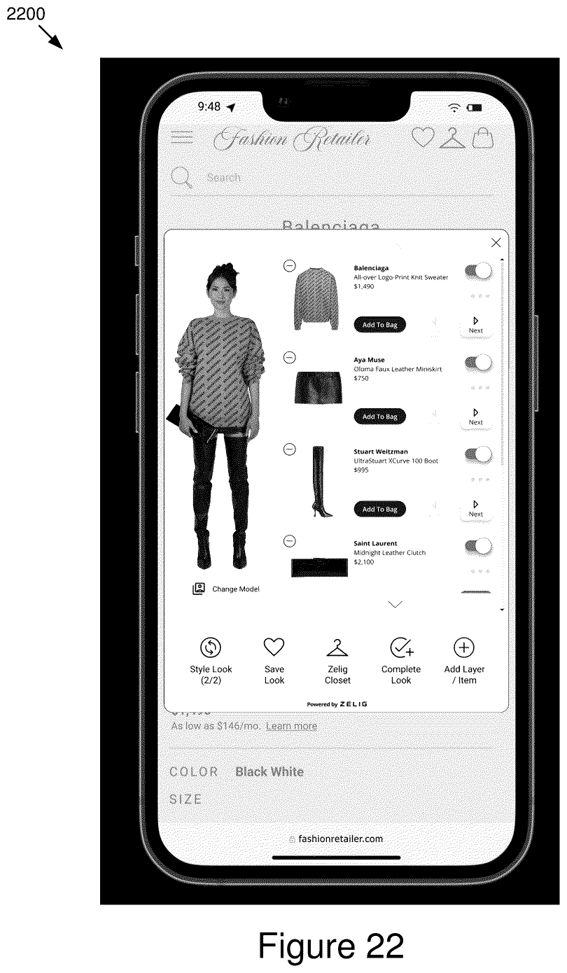

FIG. 22 is another GUI overlay display 2200 formatted for display on a mobile device. This example GUI display illustrates a personalized avatar in a complete outfit with accessories. The mobile display may be shown on, for example a mobile telephone handset, or other mobile electronic device. The mobile styler may come in various sizes, for example, small, medium, or large. It will be understood that the mobile styler may come in many other sizes. In a small mobile styler, in accordance with the systems and methods described herein, example features may include seeing items tried on in a condensed format and maximizing to show medium styler. A medium mobile styler in accordance with the systems and methods described herein may include styling variations, adding items to a bag, adding outfits to saved looks, minimizing to the small styler and maximizing to the large styler. A large mobile styler in accordance with the systems and methods described herein may include styling an outfit with recommendations, filtering recent products, adding to the cart and favorite looks.

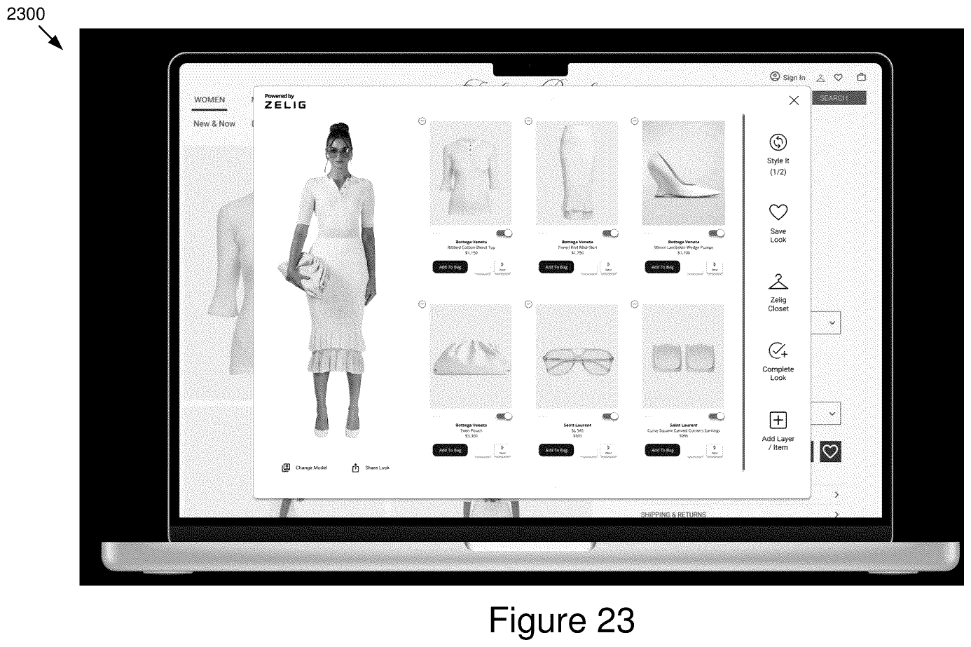

FIG. 23 is another GUI overlay display 2300 (formatted for a desktop) illustrating the human body representation or personalized avatar in a selected outfit, with a display of the items selected, including top, skirt, shoes, bag, sunglasses, and earrings.

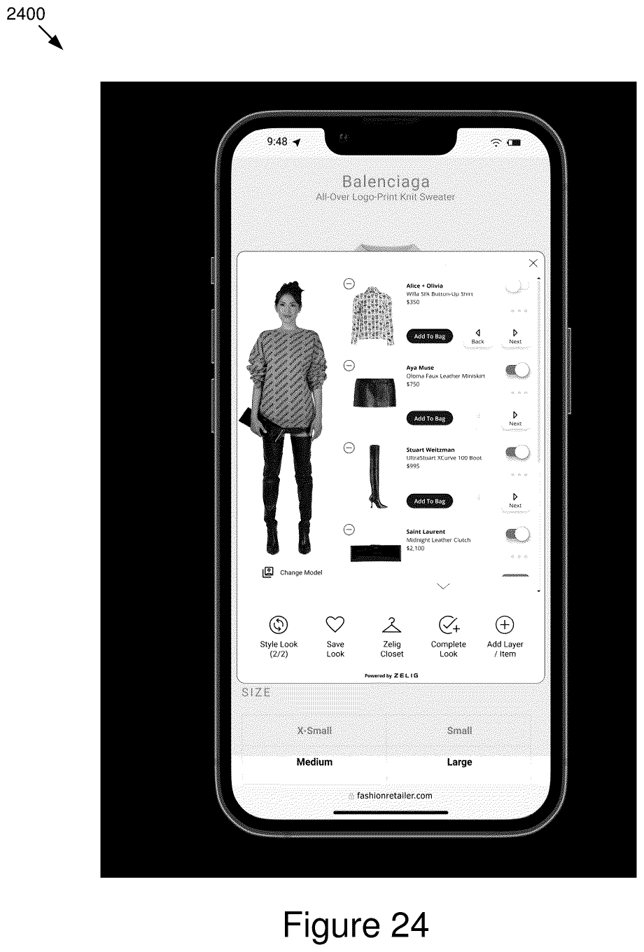

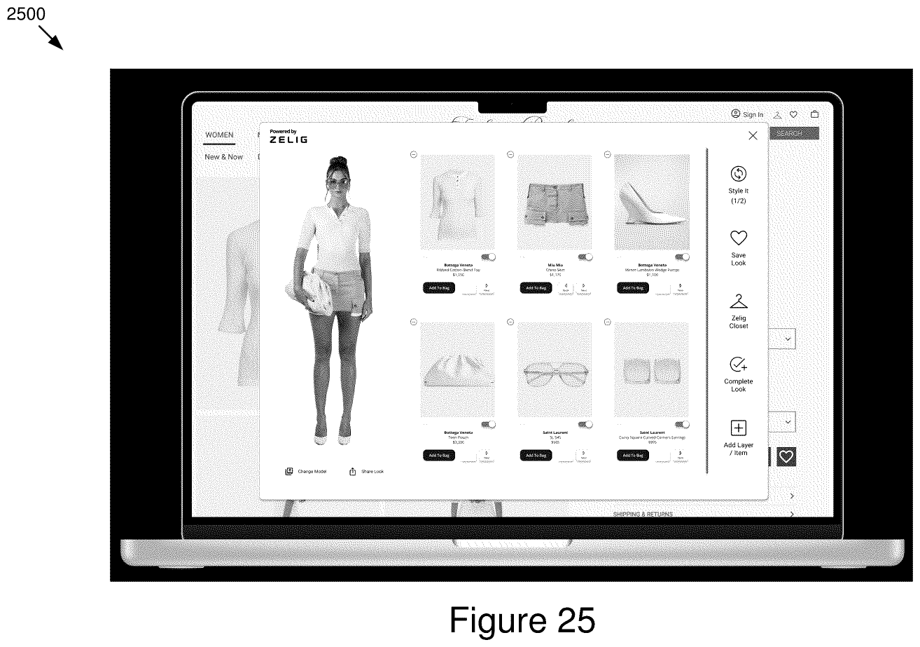

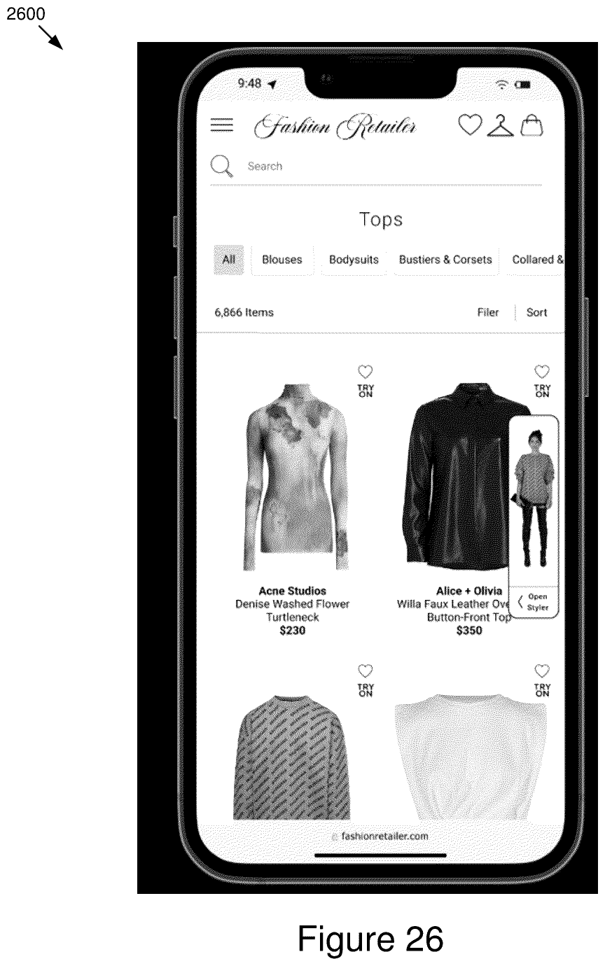

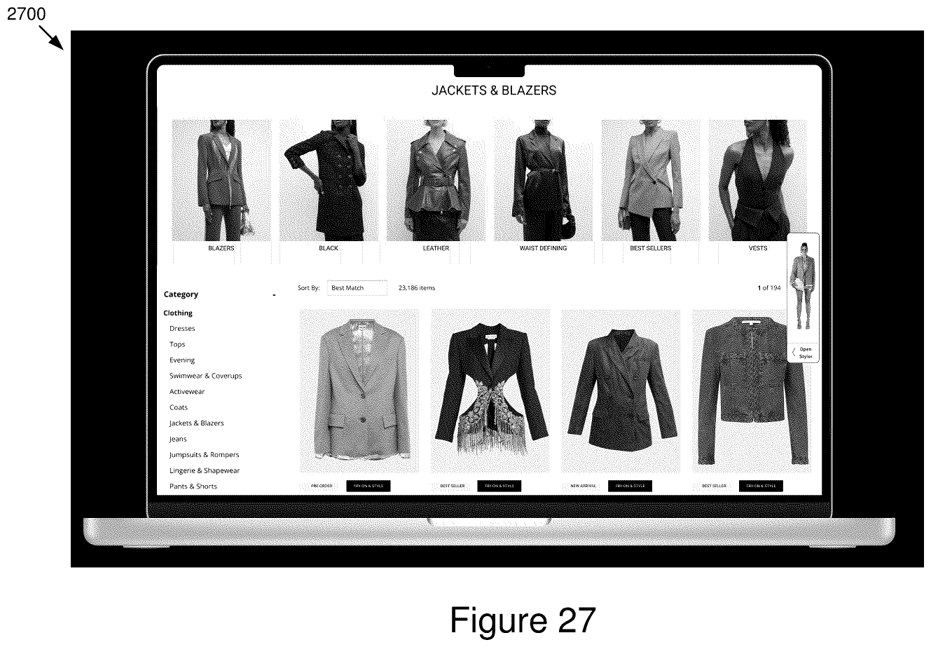

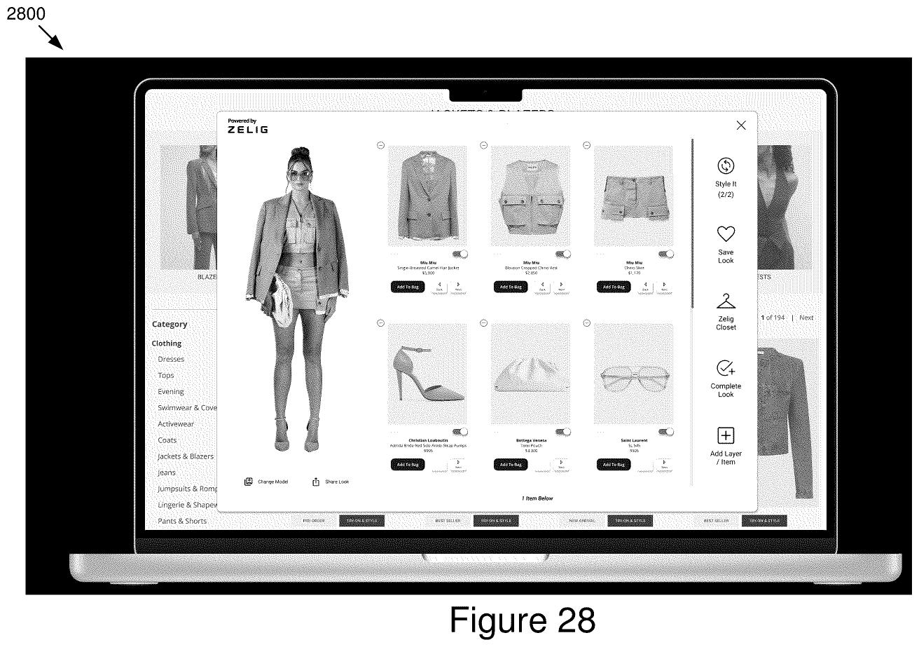

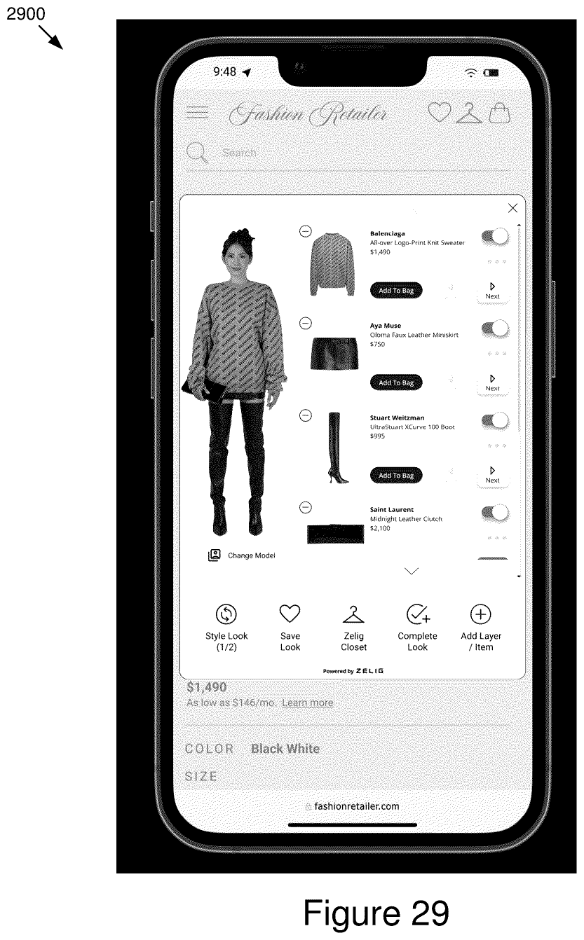

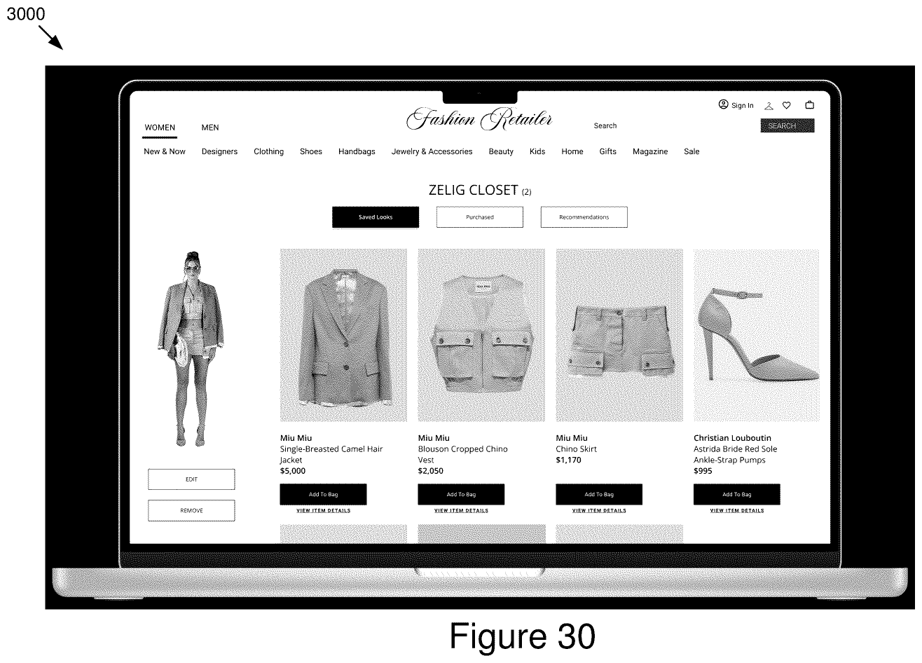

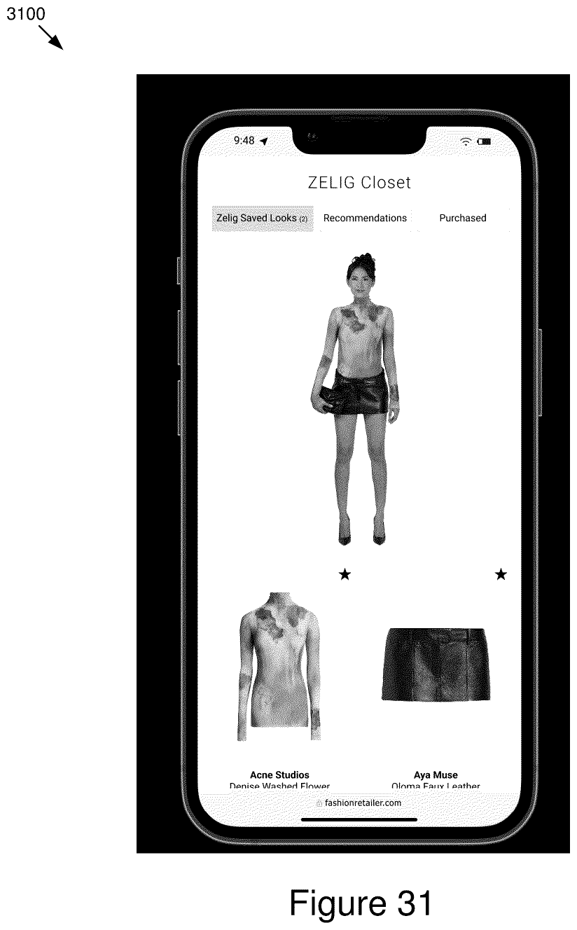

FIG. 24 is an example GUI overlay display 2400 (formatted for mobile devices) illustrating a brand, personalized avatar wearing a complete outfit and the garment selections including a top and miniskirt, boots, and a clutch bag. The other options described above are also displayed. FIG. 25 is another example GUI overlay display 2500 (formatted for desktop) showing an example human model or personalized avatar in another style selection including a selected top, chino skirt, shoes, bag, sunglasses and earrings. FIG. 26 is an example GUI overlay display 2600 (formatted for mobile devices) illustrating different brands of tops, displaying variations of tops, with a personalized avatar wearing a complete outfit and the top selections displayed in the styler widget. In this illustration, the user has left the styler interface and is now browsing the retailer's product listing pages. The last virtual outfit the user tried on is viewed on the middle-right of the screen, the “Mirror” feature formatted for mobile. FIG. 27 is an example GUI overlay display 2700 (formatted for desktop) illustrating different brands of jackets and blazers in a retailer's online display with a styler widget displaying the personalized avatar. In this example that is illustrated, if a user tried on a khaki jacket, a white shirt, and a khaki skirt, the user would view their shopper likeness wearing that exact outfit in the corner of the screen as they browse the retailer's e-commerce property. While browsing, users can opt to change their outfit, and they would view the change immediately represented on their shopper likeness without having to enter the styler interface. This is the mirror experience. FIG. 28 is an example GUI overlay display 2800 (formatted for desktop) a personalized avatar in a complete outfit including a blazer, vest, skirt, shoes, bag, and sunglasses. FIG. 29 illustrates as example GUI overlay display 2900 (formatted for mobile) illustrating a personalized avatar in a complete outfit including a top, mini skirt, boots, and clutch bag. FIG. 30 illustrates as example GUI overlay display 3000 of a closet (formatted for mobile) illustrating a personalized avatar in a complete outfit including a top, mini skirt, boots, and clutch bag that is saved by a user for later consideration. FIG. 31 illustrates as example GUI overlay display 3100 of a closet (formatted for mobile) illustrating a personalized avatar in a complete outfit (or “look”) including a top, mini skirt, shoes, and clutch bag that is saved by a user for later consideration.

Some embodiments relate to a virtual styling system for clothing that enables users to virtually style and customize their outfits. The system incorporates advanced technologies, including computer vision, augmented reality, and artificial intelligence, to provide an immersive and interactive styling experience. Users can select clothing items, experiment with different combinations, adjust parameters, and visualize the styling effects in a realistic virtual environment. The system also offers personalized recommendations and suggestions to assist users in creating unique and fashionable ensembles.

Some embodiments of the virtual styling system for clothing described herein revolutionizes the way users engage with fashion by providing a dynamic and interactive platform for virtual styling. The system utilizes cutting-edge technologies to simulate real-world clothing interactions, allowing users to explore various styles and personalize their outfits. Through an intuitive user interface and intelligent algorithms, users can experiment, receive recommendations, and create personalized looks that reflect their unique fashion preferences.

Some embodiments of the virtual styling system feature an extensive database of clothing items, including tops, bottoms, dresses, jackets, and accessories. Users can browse the database, filter items by category, style, color, or brand, and select garments to incorporate into their virtual outfits. Each clothing item may be digitally rendered to accurately represent its design, color, texture, and fit.

In some example embodiments, the virtual styling process begins with users selecting clothing items from the database and adding them to their virtual wardrobe. Users can mix and match different garments to create outfits and experiment with various styling combinations.

Some example embodiments of the system may employ computer vision and/or machine learning algorithms to analyze the user's body shape, size, and proportions based on images or video input. These algorithms generate a personalized virtual avatar that accurately represents the user's physique. The selected clothing items are dynamically fitted onto the user's virtual avatar, taking into account fabric draping, stretching, and body movement, resulting in a realistic and visually accurate representation of the outfit.

In an example embodiment, the virtual styling system offers a wide range of customization options to users. They can adjust garment parameters such as sleeve length, neckline, waistline, and hemline, enabling them to tailor the clothing items to their desired style. Users can experiment with color variations, patterns, and textures to further customize their outfits.

In some example embodiments, the system provides interactive controls that allow users to easily modify the appearance of virtual garments. Users can resize, rotate, and position clothing items on their avatar, ensuring a precise and personalized fit. Furthermore, the system offers suggestions and recommendations based on user preferences, fashion trends, and compatibility between different clothing items.

In some embodiment, to enhance the realism of the virtual styling experience, the system employs augmented reality techniques. Users can visualize their styled outfits on their virtual avatar in a realistic virtual environment. Lighting, shadows, and reflections are simulated to accurately represent how the clothing would appear in different settings and under varying conditions.

Users may view their virtual outfits from different angles, zoom in for detailed inspection, and interact with the garments through virtual touch gestures. The system provides a visually immersive experience that allows users to evaluate the styling effects and make informed decisions.

Some embodiments may include a virtual styling system utilizes artificial intelligence and machine learning algorithms to offer personalized recommendations to users. By analyzing user preferences, past interactions, and fashion trends, the system can suggest complementary clothing items, accessories, and styling ideas that align with the user's fashion taste and individual style.

In some embodiments, the virtual styling system seamlessly integrates with e-commerce platforms, allowing users to directly purchase the clothing items they style or add them to a wishlist for future reference. The system provides links to online retailers, enabling users to access additional product information and make informed purchase decisions. Users may also share their styled outfits on social media platforms, receive feedback from friends.

The present invention relates to a shirt designed with specialized markings to enhance the mapping of clothing between a model's body and a user's body in virtual try-on systems. By incorporating these markings strategically on the shirt, accurate and precise alignment of virtual clothing items on the user's body can be achieved. The shirt enables the virtual try-on system to provide a realistic and visually appealing representation of how clothing would appear on the user. Additionally, the system includes styling capabilities that allow users to personalize and customize their virtual outfits, providing an immersive and engaging virtual shopping experience.

A system in accordance with aspects of the invention leverages computing resources, including machine learning models, rendering engines, and generative AI to provide, in real time, hyper-personalized recommendations for outfits of clothing, handbags, and footwear and, furthermore, coaching to a particular user on how to wear the clothes of the outfits according to a particular fashion trend of interest, optionally in view of the user's human body type.

As used in this specification, the term style generally refers to a fashion trend that may evolve from time to time and include not only patterns of color, fabric, texture, and designs, but also how an article of clothing is cut, shaped, and/or worn. Fashion trends can be referenced by a time period in which they were popular. However, some trends don't evolve and are considered to be classic. One fashion trend, for example, is 2023's summer trend of relaxed, monochrome, and comfortable clothing, which amongst other things includes outfits consisting of crop tops, khakis shorts, and mules. Another example of a fashion trend is the bright colors and rolled up sleeves typically worn in the 80s. But style isn't just about the type, color, material, and design of clothing, it's also about how the clothing is worn, e.g., baggy, tightly, form fitting, collar up, and/or sleeves rolled.

One aspect of hyper-personalization is computer modeling and showing how articles of clothing would actually wear on the particular user in real life. The system includes rendering models and related computing resources that operate together to generate realistic digital representations of how particular articles of clothing would wear on various human body types. Moreover, the system can individually style these articles, e.g., pushing up sleeves, draping a jacket over shoulders, tucking in or half tucking a top. Hence, multiple representations are generated for each article for both various body types and for various styles. These representations can be stored on network accessible servers. The system selects the appropriate digital representations based on user input specifying the user's human body type, e.g., one or more current photos, videos, standard clothing sizes, and/or detailed measurements typically taken by a tailor. Generally, the system selects the digital representation for the particular user, but optionally can select representations for others as specified by the user (which option is useful, e.g., when the user is shopping for someone else).

Another aspect of hyper-personalization is the system's capacity to remember, learn, and predict not only the user selections of clothes and outfits, e.g., white collared blouses with black jackets, but also the user selections of style, e.g., blouse worn with sleeves rolled over jacket sleeves. The system includes generative AI resources that remembers the user's current and historical preferences, especially with respect to contemporaneous styles, learns current styles, predicts whether the user would be interested in the latter based on the former, and coaches the user on selections of outfits and styles.

The system includes servers and SDKs which can be incorporated into web pages and mobile applications, including those of high-fashion designers and retailers.

The servers include resources that are: (i) machine learning models to predict user preferences based on their previous engagements and the previous engagements of the market segments to which they belong; (ii) classifiers to classify users, articles of clothing, their combinations, and styles based on signals that include historical and current fashion trends (to generate the classification data (1016 in FIG. 10); (iii) machine learning models (1020 in FIG. 10) that, given human body types and a particular style of interest, predict how an article of clothing would wear (e.g., how it drapes, where does it stretches, and/or where it creases) on each human body type in the style of interest; (iv) a rendering engine (219 in FIG. 2) that generates digital representations of articles of clothing, including how they wear on the human body in a particular style; and (v) generative AI resources to learn about historical and current fashion trends and predicts future ones; and (vi) one or more datastores (135 in FIG. 1), including logs of user engagements, which are anonymized according to user selection.

The e-commerce system's (platform 120) SDKs include instructions to enable the system to retrieve information about articles of clothing from designers, retailers, and other B2B customers. The SDKs also include instructions to enable features and functionalities of the system in the websites and mobile applications of B2B customers, examples of which features and functionalities include those called “Complete the Look” and “Closet,” as well as “Mirror,” which is a rendering of the user or a human model, selected by the user, wearing the current articles of clothing tried on during the current session. These features and functionalities are depicted in FIGS. 18-31, and are described below in reference to these figures.

In operation, the system's server or platform ingests information specifying articles of clothing, e.g., from fashion designers and retailers and uses its computing resources (ML models, GenAI resources, and rendering engine) to process this information to generate and store digital representations of the articles, which when rendered depicts ultra-realistically how they would appear on human body types.

During a user browsing session on the designer or retailer's website or mobile application (or other computing clients of other B2B customers), the system's SDKs, which include computing instructions, work in conjunction with the system's servers to select the human body type best suited for the particular user browsing, based on a photo or video or other information submitted by the user, including user selection, which is depicted in the graphical user figures illustrated. The system's servers then send the appropriate digital representations to the websites or mobile applications or other clients for rendering, usually in response to user selection to try on the corresponding articles of clothing and style (e.g., how the article is to be worn). Moreover, servers and clients work in conjunction to provide styling guidance and recommendations to the user based on their profiles and engagements, current and historical. In response to a user selection of a call to action called “Complete the Look,” as shown in FIGS. 20, 22, and 24, the e-commerce system or platform 120 selects additional articles of clothing to recommend in accordance with the style, optionally by leveraging its AI and other computing resources to infer the style preferred by the user in the current session. The system can automatically update a rendering of the user with the additional articles of clothing and in the inferred style.

The rendering of the user wearing articles of clothing of interest in the style of interest functions as a mirror through which the user can see, in real time, what they would look like in real life. This feature is called the “Mirror,” examples of which are depicted in FIG. 26. Notably “Mirror” can appear as its own window on a display and can follow the user as they browse through various pages of a website or mobile application. In this sense “Mirror” is the digital analog of having a portable changing room with a mirror as one wanders throughout a brick-and-mortar store trying on clothes.

The Mirror functions across the system's various modes, e.g., when the user is manually selecting outfits and styles and when the user has opted to get recommendations and guidance for clothing selection and/or style options from the system. In the latter mode, the system coaches the user through their decision making and helps them keep the look going (e.g., letting the user know whether a selection of clothes or style is consistent with a fashion trend of interest).

The user can take a snapshot of the “Mirror” to store instances of it in the digital closet. (An example of this call-to-action button is shown here) Thereby, the user can recall every combination of clothing and every outfit tried on. The users can open their digital closet at any time, especially during browsing sessions when they have tried on too many outfits to keep in mind. The digital closet advantageously facilitates decision making by presenting side-by-side comparison of various outfits under consideration.

The system can be implemented as a game and/or as a B2B service for retailers and designers. It can also be implemented as a fashion coaching tool for education, not only for end users, but also for individual stylists and in-store sales associates. And it can be implemented as a service personalized for the user. In the latter case, the system can generate a digital representation of the user's particular human body (rather than match the user to one of its human body types).

Optionally, the system aggregates and where appropriate anonymizes session information and provides a dashboard of statistics to B2B customers, including reduction in merchandise rate of return and/or exchange that is enabled by the system and the corresponding savings of monetary, energy savings, and other resources. Optionally included on the dashboard are statistics of user engagements and inferences and insights gained from them, where user consent has been received. This information can enhance the personalization of recommendations.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the figures may be configured to perform one or more of the methods, features, or steps described in the figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “example” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A dynamic e-commerce method for providing an e-commerce digital journey to online users by rapid generation of images that are presented to the online customers, the method comprising:
integrating an e-commerce graphical user interface to an existing retailer's digital store, the graphical user interface generating rapid images to facilitate a real-life experience for a customer that includes styling and virtual try-on of articles of clothing at the retailer's digital store, by combining real-time images with pre-constructed images stored in a database;
providing an interactive overlay on one or more pages of the retailer's digital store, for the consumer to initiate execution of a virtual style function;
receiving a human body representation of the consumer;
providing a carousel including a plurality of articles of clothing for viewing by the customer via the graphical user interface;
receiving a selection from the customer representative of an article of clothing displayed in the retailer's digital store; and
warping a digital image of the article of clothing selected from the retailer's store to conform to the human body representation of the consumer in shape and measurement and provide a display of a synthesized image of the human body representation with the selected item of clothing.

2. The dynamic e-commerce method according to claim 1, wherein the human body representation of the consumer is generated by receiving at least one of a photo or live image of the consumer via the graphical overlay to create a personalized avatar with a likeness to the consumer.

3. The dynamic e-commerce method according to claim 1, wherein the human body representation of the consumer is generated by presenting a plurality of human body models to the consumer and receiving a selection of a particular human body model from the consumer and generating a personalized avatar for the consumer, similar in shape and measurement.

4. The dynamic e-commerce method according to claim 1, wherein the graphical overlap has a plurality of consumer interface options that the consumer executes via the graphical overlay to navigate the retailer's digital store.

5. The dynamic e-commerce method according to claim 4, wherein one of the consumer interface options is a digital closet for the consumer to store a selection of garments that the consumer has viewed via the graphical overlay.

6. The dynamic e-commerce method according to claim 5, wherein the digital closet is configured to receive item of clothing selections from a plurality of different retailer digital stores.

7. The dynamic e-commerce method according to claim 4, wherein the consumer can add the selection of items of clothing that the consumer wants to purchase directly from the closet to a retailer's shopping cart.

8. The dynamic e-commerce method according to claim 1, wherein the graphical overlay provides a query with item of clothing data relating to a consumer selection of an item of clothing to an associated database, wherein the database responds with garment metadata and a try-on image corresponding to the consumer selection.

9. The dynamic e-commerce method according to claim 1, wherein personalized avatar remains with the consumer as the consumer navigates a plurality of different retailer digital stores on a digital shopping journey.

10. The dynamic e-commerce method according to claim 1, wherein the graphical overlay sits on top of a webpage display from a retailer's digital store.

11. The dynamic e-commerce method according to claim 1, wherein the fast generation of images occurs in 1-10 seconds.

12. The dynamic e-commerce method according to claim 1, wherein the personalized avatar is created by providing the consumer a plurality of measurement criteria, including at least one from a group of a plurality of different body shapes, a plurality of different sizes, a plurality of different heights, a plurality of different skin tones, a plurality of different ethnicities, a plurality of different hair colors, and a plurality of different ages.

13. A dynamic e-commerce system for providing an e-commerce digital journey to online users by rapid generation of images that are presented to the online customer, the system comprising:
a processor;
a memory with executable code configured to cause the processor to execute an interactive graphical overlay, to execute the following actions:
integrating an e-commerce graphical user interface to an existing retailer's digital store, the graphical user interface generating rapid images to facilitate a real-life experience for a customer that includes styling and virtual try-on of garments at the retailer's digital store, by combining real-time images with pre-constructed images stored in a database;
provide the interactive graphical overlay on one or more pages of the retailer's digital store, for a consumer to initiate execution of a virtual style function;
receive a human body representation of the consumer;
providing a carousel including a plurality of garments for viewing by the customer via the graphical user interface;
receive a selection of a garment of interest displayed in the retailer's digital store from the consumer; and
warp a digital image of the garment selected from the retailer's store to conform to the human body representation of the consumer in shape and measurement and provide a display of a modified image of the human body representation with the selected garment.

14. The dynamic e-commerce system according to claim 13, wherein the human body representation of the consumer is generated by receiving a photo of the consumer via the graphical overlay to create a personalized avatar.

15. The dynamic e-commerce system according to claim 13, wherein the human body representation of the consumer is generated by presenting a plurality of human body models to the consumer and receiving a selection of a particular human body model from the consumer and generating a personalized avatar for the consumer, similar in shape and measurement.

16. The dynamic e-commerce system according to claim 13, wherein the graphical overlap has a plurality of user interface options that the consumer executes via the graphical overlay to navigate the retailer's digital store.

17. The dynamic e-commerce system according to claim 16, wherein one of the user interface options is a digital closet for the consumer to store a selection of garments that the consumer has viewed via the graphical overlay.

18. The dynamic e-commerce system according to claim 17, wherein the digital closet is configured to receive garment selections from a plurality of different retailer digital stores.

19. The dynamic e-commerce system according to claim 16, wherein the consumer can add the selection of garments the consumer wants to purchase directly from the closet to a retailer's shopping cart.

20. The dynamic e-commerce system according to claim 13, wherein the graphical overlay provides a query with garment data on a consumer selection of garment to an associated database, wherein the database responds with garment metadata and a try-on image corresponding to the consumer selection.

21. The dynamic e-commerce system according to claim 13, wherein personalized avatar remains with the consumer as the consumer navigates a plurality of different retailer digital stores.

22. The dynamic e-commerce system according to claim 13, wherein the graphical overlay sits on top of a webpage display from a retailer's digital store.

23. The dynamic e-commerce system according to claim 13, wherein the fast generation of images occurs in 1-10 seconds.

24. The dynamic e-commerce system according to claim 13, wherein the personalized avatar is created by providing the consumer a plurality of measurement criteria, including at least one from a group of a plurality of different body shapes, a plurality of different sizes, a plurality of different heights, a plurality of different skin tones, a plurality of different ethnicities, a plurality of different hair colors, and a plurality of different ages.

25. The dynamic e-commerce system according to claim 13, wherein the personalized avatar is modified by selecting different image data.

26. The dynamic e-commerce system according to claim 13, wherein the fast generation of images in transmitted in quick succession.

27. The dynamic e-commerce system according to claim 13, wherein the digital closet permits garments to be deleted and added by the consumer.

28. The dynamic e-commerce system according to claim 13, wherein the digital closet facilitates recommendations by a retailer's recommendation engine.

29. The dynamic e-commerce system according to claim 13, wherein a consumer can exit and return via the graphical interactive overlay.

30. The dynamic e-commerce system according to claim 13, wherein the graphical interface overlay includes a combination of styling, virtual try-one, the digital closet, a personalized consumer profile, a mirror feature, and a stylist approval or rejection input.
